(19) United States
(12) Patent Application Publication
(10) Pub. No.: US 2004/0223342 A1
(43) Pub. Date: Nov. 11, 2004

(54) LED inspection lamp, cluster LED, and LED with stabilizing agents

(76) Inventors: Donald L. Klipstein, Upper Darby, PA (US); George E. Cranton, London (CA); Jack Brass, Toronto (CA); Richard J. Doran, Wrotham Health (GB); Thomas M. Lemons, Marblehead, MA (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/856,088

(22) Filed: May 28, 2004

Related U.S. Application Data
(63) Continuation-in-part of application No. PCT/CA02/02020, filed on Dec. 30, 2002.
Application No. PCT/CA02/02020 is a continuation-in-part of application No. 10/029,803, filed on Dec. 31, 2001.
(60) Provisional application No. 60/359,656, filed on Feb. 27, 2002.
(60) Provisional application No. 60/474,282, filed on May 30, 2003.

(51) Int. Cl. F21V 21/00

(52) U.S. Cl. 362/555

(57) ABSTRACT

LED inspection lamps and spot lights have a plurality of LED sources. For some, radiation passing through lenses is superimposed in target area at target distance. The LED sources may be a cluster LED having more than one semiconductor die. The LED package may have a domed forward surface forward of each semiconductor die for optical purposes. The domed surface may be designed to work either with or without additional optics. The LED package may be made of epoxy having additives to resist degradation of the epoxy by ultraviolet or visible violet radiation from the LED sources. The package may be made of a material other than epoxy, such as acrylic or another thermoplastic, or a casting resin. The package may have a first, ultraviolet-resistant material that surrounds the LED chip and that is surrounded by a second material which may be epoxy.

### CROSS-REFERENCE TO RELATED APPLICATIONS

This is a continuation-in-part of co-pending International Patent Application No. PCT/CA02/02020, filed 30 Dec. 2002 (designating the U.S.) under the tide LED Inspection Lamp and LED Spot Light, which is a continuation-in-part of United States patent application no. 10/029,803, entitled LED INSPECTION LAMP, filed 31 Dec. 2001. Both of above application claim the benefit of the filing date of United States Provisional Patent Application No. 60/359,656 filed 27 Feb. 2002 under the title LED SPOT LIGHT. This application also claims the benefit of the filing date of United States Provisional Patent Application No. 60/474,282 filed 30 May 2003 under the title ULTRAVIOLET LEDS AND LED CLUSTER LAMPS, AND INSPECTION LAMPS HAVING THE SAME. This application also claims priority from the above United States Provisional Patent Application No. 60/474,282. The contents of each of the above-referenced U.S. and International applications is hereby incorporated into the Detailed Description by reference.

### TECHNICAL FIELD

This invention is related to the general field of lighting, and in particular to such lamps having light emitting diodes which produce radiation suitable for exciting fluorescent materials to be detected by such lamps, and in particular to lamps with light emitting diode light sources, and in particular to such lamps having multiple light emitting diodes that produce visible light energy. This invention is also related to the general field of light emitting diodes, and in particular to the field of light emitting diodes that produce ultraviolet or violet wavelengths suitable to cause visible fluorescence of fluorescent materials.

### BACKGROUND ART

There are many different forms of lighting technology. Incandescent, fluorescent, halogen, HID (high intensity discharge) and light emitting diodes (“LEDs”) are a few examples. Incandescent lamps are a low cost relatively inefficient way of providing visible light. Fluorescent lamps are very efficient; however, their light output is relatively low.

Halogen lamps are more efficient than incandescent lamps; but, they run quite hot, still use a fair amount of energy, and emit light over a fairly specific broad spectrum, both visible and invisible. HD lamps provide a substantial amount of light energy in invisible spectra that can be useful in particular applications, such as non-destructive testing. These lamps tend to be large, run very hot, and require warm-up and cool-down time.

There are some products that utilize LEDs. LEDs are very small, run fairly cool, and are very efficient. LEDs are also available in relatively discrete spectra for specific applications requiring spectra limits, such as sources of ultraviolet or specific colours. This allows the use of light sources without filters for these applications. This keeps costs down, simplifies set-up, and improves unit efficiency.

Examples of LED light applications include multiple LEDs grouped in a single head for low power applications, such as a flashlight or a lamp for an alternative energy household. Such lamps often have many LEDs, for example 10 or more, in order to produce enough useful light energy.

Flashlights with light emitting diodes (LEDs) have advantages over flashlights with an incandescent lamp as the light source, especially in performance when the batteries deteriorate. LEDs do not lose efficiency the way incandescent lamps do when the amount of power supplied to the lamp decreases. Another advantage of LED flashlights is greater spectral content in the blue-green and blue wavelengths favorable to night vision compared to flashlights with incandescent lamps.

Others have used single or multiple LED lamps in leak detection applications. These lamps have advantages in size and power consumption; however, they also suffer from relatively low useful light energy.

Detection of leaks in systems containing fluids under pressure is often accomplished by causing visible fluorescence of fluorescent dyes that are added to the fluid in the system. Such systems may be, for example, refrigeration systems where the fluid under pressure is a refrigerant and leakage results in the fluid becoming an invisible gas upon escape. The invisibility of leaked fluid can impair detection of the leak. Addition of a fluorescent dye to the refrigerant allows easier detection of leaks by illuminating possible leakage points with radiation that causes the fluorescent dye to visibly fluoresce at the site of the leak.

Leak detection by means of use of a fluorescent dye is also used in systems other than refrigeration systems, such as automotive cooling systems and in engines having a lubricant that is under pressure.

There are many inspection lamps currently available for the purpose of illuminating potential leak sites with radiation cause visible fluorescence of fluorescent dyes. It is desirable to minimize the size, weight, cost, heat production and power consumption of such inspection lamps while having adequate output from such lamps at wavelengths suitable for causing visible fluorescence of dyes used for leak detection.

Light emitting diodes (LEDs) are used as a source of light for such inspection lamps. LEDs are more efficient at producing desired wavelengths than other light sources used in such inspection lamps. LEDs are also relatively small and produce relatively little heat. Existing LED inspection lamps have had 4 LEDs in an attempt to produce sufficient intensity at a usable distance to make a fluorescent dye fluoresce. For some situations this defeats the purpose of the LED source as additional power must be consumed and the size of the lamp is increased accordingly.

In traditional inspection lamps a broadband light source is utilized, such as an incandescent or halogen bulb. This can have an advantage over LED sources as these sources have a greater radiation output, and they emit radiation over a broad spectrum that can cause a variety of fluorescent dyes to fluoresce. LEDs have a tendency to produce light only in a narrow range of wavelengths.

However, traditional lamps suffer from a number of drawbacks. The broadband light source produces mostly radiation that is not used for detection of any fluorescent dye that has frequent use for leak detection. Also, some of the radiation may be at wavelengths normally emitted by the fluorescent materials to be detected. Filters are typically used to remove such wavelengths from the output of the inspection lamp so that light from the inspection lamp does not mask fluorescence of the fluorescent material to be detected. Radiation absorbed or reflected by filters results in heat, often necessitating means to dissipate this heat.

Alternatively, inspection lamps have been produced using electric discharge light sources since such light sources are often more efficient than incandescent light sources at producing wavelengths suitable for causing visible fluorescence of materials used for leak detection. Such inspection lamps have their own disadvantages such as the cost of the special discharge light sources, the added cost of electrical components required for operation of such light sources, a requirement for some such light sources to spend time warming up to a required elevated operating temperature in order to properly function, and the tendency of many discharge light sources to specialize in production of wavelengths not effectively utilized by all popular fluorescent dyes.

As mentioned previously, UV LEDs or LEDs that provide significant UV radiation can be used for many different applications including, for example, in inspection lamps that are used to detect fluorescent materials, such as leaks of fluids under pressure where the fluids have a suitable fluorescent dye. Unlike most light emitting diodes which have their light emitting diode (LED) chips encapsulated in epoxy packages, these light emitting diodes typically have their chips in hollow containers that lack an encapsulate. This is because the usual epoxy encapsulates are not sufficiently transparent to ultraviolet radiation or are discolored by the ultraviolet radiation produced by the LED chips. Unfortunately, the lack of an encapsulate results in a reduction of radiation output as the LED chip is surrounded by a medium (air) having a refractive index that is lower than, and worse than epoxy at being significantly different from, the refractive index of the chip material.

In an attempt to increase radiation output, ultraviolet light emitting diodes having chips encapsulated in epoxy packages are available. Epoxy has a higher refractive index than air does; so, epoxy's refractive index is closer to that of the LED chip material. Initially, ultraviolet LEDs with epoxy packages produce more radiation output than ultraviolet LEDs made with hollow containers do; however, over time, the epoxy near the LED chip is damaged by the ultraviolet radiation and this causes the output of these LEDs to significantly degrade within a few hundred hours of operation LEDs having peak wavelength as long as 420 nm, in the blue-violet range of the visible spectrum, degrade significantly after several hundred hours of operation.

There is a need to derive the full benefit of utilizing LED light sources in inspection lamps. There is also a need to retain some of the benefits of traditional light sources. Further improvements in lighting technology are desirable. It is an object of the invention to address these or other issues associated with LEDs and LED lamps.

### DISCLOSURE OF THE INVENTION

In a first aspect the invention provides an inspection lamp having light emitting diodes as a source of radiation suitable for causing visible fluorescence of fluorescent materials, where said light emitting diodes are substantially non-identical in spectral characteristics of their emitted radiation, such that at least one but not all of said light emitting diodes in said inspection lamp produce wavelengths of radiation that are favorable for causing visible fluorescence of some fluorescent materials, and such that one or more different said light emitting diodes in said inspection lamp produce substantially different wavelengths of radiation which are more favorable than the wavelengths of first said light emitting diode(s) for causing visible fluorescence of some fluorescent materials other than first said fluorescent materials.

At least one light emitting diode may have a peak emission wavelength in the ultraviolet and at least one light emitting diode may have a peak emission wavelength that is visible but suitable for causing visible fluorescence of fluorescent materials.

At least one light emitting diode may produce mostly blue visible light and at least one light emitting diode may produce mostly visible violet light or ultraviolet radiation.

At least one light emitting diode may have a peak emission wavelength in the range of 425 to 480 nanometers and at least one light emitting diode may have a peak emission wavelength in the range of 360 to 430 nanometers.

The inspection lamp may have one or more lenses to collimate the radiation produced by at least some of the light emitting diodes. The radiation produced by each light emitting diode may be collimated by a separate lens associated with or mounted forward from each said light emitting diode.

The inspection lamp may have a handle. The handle may share a longitudinal axis with the inspection lamp as a whole. The handle may not share an axis with any other major portion of said inspection lamp.

The inspection lamp may accept one or more dry cells as a source of power. The inspection lamp may accept power from an external power source. The external power source may be a source of direct current with a voltage of substantially 12 volts. The external power source may be a source of alternating current with a voltage of substantially 110-125 volts. The external power source may be a source of alternating current with a voltage of substantially 220-240 volts. The inspection lamp may have one or more rechargeable cells as a source of power. The inspection lamp may have means to recharge its rechargeable cells.

The inspection lamp may have one or more dropping resistors to limit the amount of current which flows through at least one of the light emitting diodes. The inspection lamp may have non switching current regulation means to control the amount of current which flows through at least one of the light emitting diodes. The inspection lamp may have switching current regulation means to control the amount of current which flows through at least one of the light emitting diodes. The inspection lamp may be of such design that at least one of the light emitting diodes does not require separate means to limit or control the amount of current flowing through said light emitting diode.

Any of the light emitting diodes may be laser diodes. The laser diodes may be intended to normally operate in a laser mode. The laser diodes may be intended to normally operate in a non-laser mode. Oblong beams from each laser diode may be directed into different directions so as to achieve an overall beam pattern that is not oblong. The inspection lamp may have optical means to correct oblong characteristics of the beams produced by most types of laser diodes. The inspection lamp may have one more cylindrical lenses to correct oblong characteristic of the laser diodes. The inspection lamp may have optics other than cylindrical lenses to correct oblong beam characteristic of laser diodes. The inspection lamp may be of such design as to produce beams not having the oblong characteristic typical of laser diodes. In a second aspect the invention provides a module having light emitting diodes that are substantially non-identical and which produce a variety of wavelengths suitable for exciting a variety of fluorescent dyes, and suitable for replacing the bulb and/or the reflector of a flashlight so as to achieve an inspection lamp. The inspection lamp may contain one or more of the modules.

The inspection lamp may have one or more light emitting diode modules, where at least one light emitting diode module has only one type of light emitting diode but the inspection lamp as a whole includes more than one type of light emitting diode so as to produce a variety of wavelengths suitable for exciting a variety of fluorescent dyes.

In a third aspect the invention provides an inspection lamp having two or more light emitting diodes that produce radiation suitable for causing visible fluorescence of fluorescent materials, and a lens forward from each of said light emitting diodes to collimate the radiation from each light emitting diode into a beam, such that the beams of radiation individually associated with each of said light emitting diodes project forward from said lenses and merge together.

The individual beams that project forward from each lens may be parallel to each other. The individual beams may converge towards each other such that the axes of the beams intersect with each other at a specific distance forward of the lenses. The individual beams may have an angular diameter greater than any angle between any two axes of said beams, such that some area can be illuminated by all said beams at any distance from the lenses greater than distance from the lenses to the point at which the beam axes intersect.

The lenses may be comprised by a single piece of suitable transparent material. Each lens may have a center of curvature of at least one curved surface displaced from the axis of its associated light emitting diode so as to form a beam having an axis that is not parallel to said axis of said light emitting diode.

A lens assembly may have a longitudinal axis and convex lenses each having at least once curved surface with a center of curvature at a location other than on a line parallel to said lens assembly axis and passing through the center of the area of said lens, so as to be suitable as the lenses of the inspection lamp.

As stated previously for other aspects, the inspection lamp may or may have a handle, and use a variety of internal or external power sources with or without current limiting devices

The light emitting diodes may differ significantly in spectral characteristics so as to cause visible fluorescence from fluorescent substances which visibly fluoresce from the output of one or more but not all of said light emitting diodes.

Separate switches may be provided for each type of light emitting diode used within said inspection lamp.

At least one light emitting diode may have a peak wavelength that is ultraviolet and at least one light emitting diode may have a peak wavelength that is visible. At least one light emitting diode may have a peak wavelength less than 425 nanometers and at least one light emitting diode may have a peak wavelength greater than 425 nanometers.

In a fourth aspect the invention provides an LED inspection lamp having a plurality of LED sources. Each source emits electromagnetic radiation at a different peak wavelength. Each different peak wavelength causes visible fluorescence in a different leak detection dye. A lens may be associated with each LED so that radiation passing through all lenses from their associated LEDs is substantially superimposed to a target area at a target distance from the lenses.

In a fifth aspect the invention provides an LED inspection lamp having a single LED for emitting electromagnetic radiation at a peak wavelength for causing visible fluorescence in a leak detection dye, and a lens associated with the LED so that substantially all of the radiation passes through the lens and is substantially directed to a target area at a target distance from the lenses.

In a sixth aspect the invention provides an LED inspection lamp having a plurality of LEDs emitting electromagnetic radiation at a peak wavelength for causing visible fluorescence in a leak detection dye, and a lens associated with each LED so that the electromagnetic radiation passing through all lenses from their associated LEDs is substantially superimposed to a target area at a target distance from the lenses.

In a seventh aspect the invention provides a lens adaptor having a lens housing for attachment to an LED inspection lamp with a single LED emitting electromagnetic radiation at a peak wavelength for causing visible fluorescence in a leak detection dye, and a lens within the housing. The lens and housing are associated with the LED so that substantially all of the radiation passing through the lens from the LED is substantially directed to a target area at a target distance from the lenses.

In an eighth aspect the invention provides a lens adaptor having a lens housing and lenses. The lens housing is for attaching to an LED inspection lamp with a plurality of LEDs emitting electromagnetic radiation at a peak wavelength for causing visible fluorescence in a leak detection dye. The lenses are for associating with each LED when the lens housing is attached to the inspection lamp. Radiation passing through all lenses from their associated LEDs is substantially superimposed to a target area at a target distance from the lenses.

In a ninth aspect the invention provides a lens and LED assembly for use within a flashlight casing. The assembly has a plurality of LEDs emitting electromagnetic radiation at a peak wavelength for causing visible fluorescence in a leak detection dye, and a lens associated with each LED so that the electromagnetic radiation passing through all lenses from their associated LEDs is substantially superimposed to a target area at a target distance from the lenses. The assembly is shaped to fit within the flashlight casing.

In any of the aspects a lens may be movable to permit adjustment of beam characteristics. The focal length of the lenses and the distance between the lenses (or lens assembly and the light emitting diodes) may be adjustable so as to permit changing the distance at which beam size and intensity formed by each light emitting diode and each associated lens are best-formed. The distance between lens centers may be smaller than the distance between the centers of their associated light emitting diodes so that the beam components formed by each lens from its associated light emitting diode converge towards each other.

The beam components formed by each lens from its associated light emitting diode may converge towards each other so that all beam components coincide at a distance which can be changed by changing the location of the LEDs.

An inspection lamp may further incorporating means to restrict the possible adjustments to a range of adjustments where the beam elements are best-formed at the same distance forward from said inspection lamp at which said beam elements are coinciding with each other.

In a tenth aspect the invention provides a light producing assembly having two or more light emitting diodes. The assembly also has a lens forward from each of the light emitting diodes such that the light from the light emitting diodes is collimated into a beam.

In an eleventh aspect the invention provides a spot light having two or more light emitting diodes. The spot light also has a lens forward from each of the light emitting diodes such that the light from the light emitting diodes is collimated into a beam.

Each of one or more of the LEDs may be offset from the optical center of its associated lens to cause the radiation passing through the lenses to be substantially superimposed to a target area at a target distance

The spot light may have a light producing assembly. The spot light may be suitable for use as a fixed spot light. The spot light may be able to accept as a power source essentially 120 volts alternating current, 230 volts alternating current, 12 volts direct current, or 28 volts direct current, such as from a battery source.

The spot light may be able to accept direct current as a power source. The spot light may be able to accept direct current as a power source and operate even if the polarity of the direct current is reversed.

The spot light may have light emitting diodes that are essentially identical. The spot light may have light emitting diodes that produce white light. The spot light may have LEDs that produce visible light of different colors. The spot light may have light emitting diodes including red, green and blue light emitting diodes to achieve essentially white light. The spot light may be a flashlight.

The spot light may have light emitting diodes that individually produce light of different colors that combine to form light that is essentially white. The spot light may have orange, blue-green and violet light emitting diodes that are used to achieve essentially white light. The spot light may have yellow, turquoise and magenta or yellow, green and blue light emitting diodes that are used to achieve essentially white light.

The spot light may have light emitting diodes essentially of two complimentary colors that are used to achieve essentially white light. The spot light may have light emitting diodes of more than three distinct colors. The spot light may produce essentially yellow light.

The lenses may be part of a lens assembly that can be moved with respect to the light emitting diodes. The lens assembly may be part of an assembly that slides over the light emitting diodes. The spot light may have a thumbwheel for use to adjust the distance between the lens assembly and the light emitting diodes. The distance between the lenses and the light emitting diodes may be adjustable by rotating a collar that moves the lenses.

In a twelfth aspect the invention provides an LED spot light having a plurality of LEDs emitting electromagnetic radiation. The spot light also has a lens associated with each LED so that the electromagnetic radiation passing through all lenses from their associated LEDs is substantially superimposed to a target area at a target distance from the lenses.

In a thirteenth aspect the invention provides a lens adaptor having a lens housing and lenses. The lens housing is for attachment to an LED spot light with a plurality of LEDs emitting electromagnetic radiation. The lenses are associated with each LED when the lens housing is attached to the spot light so that the radiation passing through all lenses from their associated LEDs is substantially superimposed to a target area at a target distance from the lenses.

In a fourteenth aspect the invention provides a lens and LED assembly. The assembly has a plurality of LEDs emitting electromagnetic radiation. The assembly also has a lens associated with each LED so that the electromagnetic radiation passing through all lenses from their associated LEDs is substantially superimposed to a target area at a target distance from the lenses.

The distance between the lenses and LEDs may be adjustable so as to permit changing the distance at which beam components formed by each light emitting diode and each associated lens are best focused.

The LED locations may be changeable to permit adjustment of the convergence angle formed by each lens/LED relationship to change the best focus distance.

The distance between lens centers may be smaller than the distance between the centers of their associated light emitting diodes so that the beam components formed by each lens from its associated light emitting diode converge towards each other.

The beam components may be formed by each lens from its associated light emitting diode converge towards each other so that all beam components coincide at a distance which can be changed by changing the distance between the lenses and the LEDs.

The distance between the lenses and the light emitting diodes may be adjustable so as to permit adjustment of the distance at which beam components are focused in addition to permitting adjustment of the distance at which beam elements are coinciding with each other. The distance between the lenses and the LEDs may be adjustable by means of a thumbwheel. The distance between the lenses and the LEDs may be adjustable by rotating a collar that changes the distance between the lenses with respect to the LEDs.

A fourteenth aspect of the invention is changing the focal length of the lenses to increase the size of the spot of light by decreasing the focal length of the lenses and the distance between the lenses and LEDs or to reduce the size of the spot of light by increasing the focal length of the lenses and the distance between the lenses and LEDs.

The distance separating the LEDs from each other may be adjustable along with the distance between the lenses and the LEDs. The distance separating the LEDs and the distance between the lenses and the LEDs may both be adjusted by the same adjustment.

The lenses may be within and spaced about a single lens mount, and the LEDs may be mounted on a printed circuit board. An assembly may also have a spacer through which the LEDs project, the spacer for correctly spacing the LEDs with respect to one another for alignment with the lenses.

There may be a separator between the lenses and the LEDs, such that light from each LED cannot pass through the separator to a lens not associated with LED, and light from each LED can pass through the separator to the lens associated with that LED.

There may be a baffle that includes the spacer and the separator. The baffle and lens mount may be fixed to one another to limit relative movement of the baffle and the lens mount. The printed circuit board may be held in fixed relationship to the lens mount, with a desired distance between the lenses and their associated LEDs. The lens mount may have a tubular body extending away from the lenses, and the baffle may fit within the tubular body until the separator meets the lens mount about the lenses.

The lens mount may have a tubular body extending away from the lenses, and the printed circuit board may be fixed to the tubular body.

In a fifteenth aspect the invention provides an LED lamp including an LED source having a plurality of LED chips with each chip producing a beam of radiation. It also includes a plurality of lenses with each lens capturing a beam of radiation from an LED chip of the LED source. The lenses collimate the captured beams of radiation to produce collimated beams of radiation and the lenses merge the collimated beams of radiation at a target distance.

The LED source may be a LED cluster including the plurality of LED chips within a single encapsulant package. The lenses may be part of the encapsulant package.

In a sixteenth aspect the invention provides an LED lamp including an LED source having a plurality of LED chips with each chip producing a beam of radiation. It also includes a plurality of lenses with each lens for capturing a beam of radiation from an LED chip of the LED source. The lenses collimate the captured beams of radiation to produce collimated beams of radiation and the lenses merge the collimated beams on radiation at a target distance. The LED chips emit radiation including wavelengths of 425nm or less.

In a seventeenth aspect the invention provides an LED source including a plurality of LED chips with each chip producing a beam of radiation with at least one anode for connection, directly or indirectly, between a source of power for the LED source and one of the LED chips. The source also includes at least one cathode for connection, directly or indirectly, between a source of power for the LED source and one of the LED chips. The source further includes an encapsulant for encapsulating each of the LED chips. The encapsulated LED chips are part of a single encapsulant package. The radiation from the LED chips is emitted from the encapsulant package. The encapsulant includes a stabilizing agent; so that, the encapsulate resists degradation by radiation produced from the LED chips, while allowing desired radiation from the LED chips to pass through the encapsulant and exit the LED.

The encapsulant may include an epoxy. The stabilizing agent may include an antioxidant The antioxidant may be a hydrogen donor. The hydrogen donor may include a substituted phenol. The substituted phenol may include those with substituents in the 4- position. The substituted phenol may include those with substituents providing steric hindrance in the 2,6- position.

The antioxidant may be a hydroperoxide decomposer. The hydroperoxide decomposer may be a phosphate. The hydroperoxide decomposer may be a phosphonite. The hydroperoxide decomposer may be a sulfie. The hydroperoxide decomposer may be a dialkyldithiocarbamate. The hydroperoxide decomposer may be a dithiophosphate.

The antioxidant may include a radical scavenger. The radical scavenger may be a tetramethyl piperidine derivative.

The encapsulant may include a light stabilizer. The light stabilizer may include a quencher. The light stabilizer may include a non-UV absorber-light stabilizer. The non- UV absorber light stabilizer may be a substituted tetramethylpiperidine derivative. The substituted tetramethylpiperidine derivative may include a sebacate. The sebacate may be a bis(1-octyloxy-2,2,6,6-tetramethyl-4-piperidyl) sebacate.

The light stabilizer may include a UV absorber. The UV absorber may include a substituted derivative of benzophenone. The substituted derivative of benzophenone may be a hydroxybenzophenone. The hydroxybenzophenone may be 2,4-dihydroxybenzophenone. The hydroxybenzophenone may be 2,2′-dihydroxy-4,4′-dimethoxybenzophenone. The 25 hydroxybenzophenone may be 2-hydroxy-4-methoxybenzophenone.

The UV absorber may be a substituted derivative of benzotriazole. The substituted derivative of benzotriazole may be a phenylbenzotriazole. The phenylbenzotriazole may be 2-(2-hydroxy-5-methylphenyl) benzotriazole. The phenylbenzotriazole may be 2-(2H-benzotriazol-2-yl)-4,6-di-tert-pentylphenol. The UV absorber may include a substituted hydroxyphenyl triazine.

The encapsulant may include a polyacrylate. The encapsulant may include a styrene. The encapsulant may include a carbonate. The encapsulant may include an urethane. The encapsulant may include an amide. The encapsulant may include an acetal. The encapsulate may include an olefin. The encapsulant may include a copolymer of two or more polyacrylates, styrenes, carbonates, urethanes, amides, acetals and olefins.

The encapsulant package may be shaped to produce, for each LED chip, a round image of the radiation emitted from each LED chip forward of the LED chip. The encapsulant package may include a plurality of lenses forward from the LED chips, wherein each lens captures a beam of radiation from an LED chip of the LED source, the lenses collimate the captured beams of radiation to produce collimated beams of radiation, and the lens merge the collimated beams of radiation at a target distance

In an eighteenth aspect the invention provides an LED lamp including an LED source of one of the other aspects, and a plurality of lenses separate from the encapsulant package, and forward from the LED chips. Each lens captures a beam of radiation from an LED chip of the LED source. The lenses collimate the captured beams of radiation to produce collimated beams of radiation. The lens merge the collimated beams of radiation at a target distance.

In a nineteenth aspect the invention provides a LED, including one or more LED chips encapsulated in an encapsulant package. The one or more LED chips have a peak emission wavelength of less than 425 nm. The encapsulant is epoxy mixed with a stabilizing agent to resist damage to the epoxy by radiation from the LED chip(s) while allowing desired radiation from the LED chips to pass through the encapsulant and exit the LED.

The encapsulant may include a mixture in which a piperidyl sebacate is combined with at least one of a benzophenone or benzotriazole in the range of 0.01-0.5 percent by weight of the encapsulate.

In a twentieth aspect the invention provides a light emitting diode having one or more LED chips encapsulated in an encapsulant package. The LED chip(s) have a peak emission wavelength of less than 425 nm. The encapsulant is epoxy mixed with a phenolic inhibitor to resist damage to the epoxy by radiation from the LED chip(s).

In a twenty-first aspect the invention provides a light emitting diode having one or more LED chips encapsulated in an encapsulant package. The LED chip(s) have a peak emission wavelength of less than 425 nm. The encapsulant is epoxy mixed with a hindered amine light stabilizer to resist damage to the epoxy by radiation from the LED chip(s).

In a twenty-second aspect the invention provides a light emitting diode having one or more LED chips encapsulated in an encapsulant package. The LED chip(s) have a peak emission wavelength of less than 425 nm. The encapsulant is epoxy mixed with a dye that absorbs radiation produced by the LED chip(s) so as to resist damage to the epoxy by radiation from the LED chip(s) while allowing desired radiation from the LED chips to pass through the encapsulant and exit the LED.

In a twenty-third aspect the invention provides a light emitting diode having one or more LED chips encapsulated in an encapsulant package. The LED chip(s) have a peak emission wavelength of less than 425 nm. The encapsulant is an acrylic. The acrylic may be polymethylmethacrylate.

In a twenty-fourth aspect the invention provides a light emitting diode having one or more LED chips encapsulated in an encapsulant package. The LED chip(s) have a peak emission wavelength of less than 425 nm. The encapsulant is a combination of an acrylic and polystyrene.

The encapsulant may be in the form of a casting resin.

The stabilizing agent may include an antioxidant.

In a twenty-fifth aspect the invention provides an LED inspection lamp using one of the LEDs of the above aspects. The LED may include additional circuitry. The additional circuitry may limit or regulate current through the LED.

The LEDs of the above aspects may be cluster LEDs having at least two LED chips. The cluster LEDs may include a domed region forward of each LED chip for optical purposes. The domed regions may have such optical properties as to form a usably collimated beam of radiation from the LED chips without additional optics. The domed regions may have such optical properties that additional optics would be used in order for a suitably collimated beam of radiation from the LED chips to be formed.

In a twenty-sixth aspect the invention provides a LED having one or more LED chips encapsulated in an encapsulant package. The LED chip(s) have a peak emission wavelength of less than 425 nm. The encapsulant package includes an inner layer surrounding the LED chip. The inner layer is an encapsulant material which is not damaged by ultraviolet radiation as easily as epoxy is. The encapsulant package also includes an outer layer which is a rigid material. The inner layer of the encapsulant package may be rigid. The inner layer of the encapsulate package may be in the form of a casting resin. The inner layer may include an acrylic. The acrylic may be polymethylmethacrylate. The inner layer may include polystyrene. The inner layer may be a polycarbonate.

In a twenty-seventh aspect the invention provides an inspection lamp, suitable for causing visible fluorescence of visibly fluorescent substances. The lamp includes at least one cluster LED as set forth in the above aspects. The LED inspection lamp may also include additional optics typically required to form a collimated beam of radiation from the cluster LED.

In a twenty-eighth aspect the invention provides an inspection lamp, suitable for causing visible fluorescence of visibly fluorescent substances. The lamp includes a cluster LED as set forth in the above aspects.

In a thirtieth aspect the invention provides an epoxy encapsulate, suitable for making LEDs having a peak wavelength of less than 425 nanometers. The encapsulant includes a stabilizing agent to resist damage to the epoxy by radiation produced by LED chips in the LEDs.

In a thirty-first aspect the invention provides a LED, suitable for use in an LED inspection lamp. The LED includes two or more LED chips with a peak wavelength of less than 425 nanometers in a single encapsulant package.

In a thirty-second aspect the invention provides a LED, suitable for use in an LED inspection lamp. The LED includes: two or more LED chips with a peak wavelength of between 425 and 450 nanometers in a single encapsulant package.

In a thirty-third aspect the invention provides a LED including one or more LED chips, an encapsulant for encapsulating one or more of the LED chips, and a stabilizing agent within the encapsulant. The stabilizing agent resists degradation of the encapsulant by radiation emitted from one or more of the LED chips.

The encapsulant may include an epoxy. The stabilizing agent may include one or more of a phenolic inhibitor, an antioxidant, a hindered amine light stabilizer, a light stabilizer other than hindered amine light stabilizers, and a light absorber that absorbs damaging wavelengths while transmitting desirable wavelengths. One or more of the LED chips emits radiation at a peak wavelength of 425 nm or less. The encapsulant may include one or more domed regions, each domed region being forward of an LED chip.

In a thirty-fourth aspect the invention provides a LED lamp including a cluster LED of one of the above aspects with domed regions, and a lens forward of each domed region of the LED. The lenses may collimate beams produced by the LED.

In a thirty-third aspect the invention provides a flashlight including a cluster LED of one of the above aspects. Other aspects and embodiments of the invention are set out elsewhere herein, or will be evident to those skilled in the art based on the principles presented herein.

### BRIEF DESCRIPTION OF THE DRAWINGS

For a better understanding of the present invention and to show more clearly how it may be carried into effect, reference will now be made, by way of example, to the accompanying drawings that show the preferred embodiment of the present invention and in which:

FIG. 1 is an external view showing the front, top, and left side of a light according to a preferred embodiment of the invention,

FIG. 2 is a cross sectional view through the line A-A′, looking from above, of the light of FIG. 1,

FIG. 3 is an external view showing the front, top and left side of a light according to an alternate preferred embodiment of the invention,

FIG. 4 is a cross sectional view through the line B-B′, looking from above, of the light of FIG. 3,

FIG. 5 is a cross sectional view looking from above of a light according to a further alternate preferred embodiment of the invention,

FIG. 6 is a schematic diagram of an example alternative electrical circuit for lights according to the preferred embodiments that have multiple LED sources,

FIG. 7 is a schematic diagram of an example further alternative electrical circuit for lights according to the preferred embodiments that have multiple LED sources,

FIG. 8 is an external view showing the front, top, and left side of a light according to a further alternate preferred embodiment of the invention,

FIG. 9 is a cross sectional view through the line C-C′, looking from above, of the light of FIG. 8,

FIG. 10 is an external view showing the front, top, and left side of a lens/LED assembly according to a preferred embodiment of the invention,

FIG. 11 is a frontal view of a lens assembly according to a preferred embodiment of the invention,

FIG. 12 is a side cross sectional view through the line D-D′of the lens assembly of FIG. 11,

FIG. 13 is a cross-section view of a lens adapter according to a preferred embodiment of the invention in use with a multiple LED inspection light,

FIGS. 14-18 are ray diagrams of illustrating some of the factors utilized in the preferred embodiments of the invention,

FIG. 19 is an image of the light of FIG. 8 at 6 inches,

FIG. 20 is an image of the light of FIG. 8 at 11 inches,

FIG. 21 is an image of the light of FIG. 8 at 20 inches,

FIG. 22 is a cross sectional view looking from above of a light according to a further alternate preferred embodiment of the invention,

FIG. 23 is an external view showing the front, top, and left side of a Light according to another further alternate preferred embodiment of the invention, FIG. 24 is a cross sectional view through the line E-E′, looking from above, of the light of FIG. 23,

FIG. 25 is a cross sectional view of an adjustable embodiment of the light of FIG. 23,

FIG. 26 is a frontal view of a lens assembly according to a preferred embodiment of the present invention,

FIG. 27 is an external view showing the front, top, and left side of a lens/LED assembly according to a further preferred embodiment of the invention

FIG. 28 and 29 are ray diagrams that illustrate the increase and decrease of the image size as the lens focal length is decreased and increased,

FIG. 30 is a cross sectional view of a variation of an adjustable embodiment of the light of FIG. 23,

FIG. 31 is a cross sectional view of the adjustable embodiment shown in FIG. 30 as it is affected by adjustment,

FIG. 32 is an external view of a further alternate adjustable preferred embodiment of the present invention,

FIG. 33 is a perspective view of a baffle employed in a preferred embodiment of the present invention,

FIG. 34 is perspective view from in front of a lens mount employed in a preferred embodiment of the present invention,

FIG. 35 is perspective from behind the lens mount of FIG. 34,

FIG. 36 is an exploded perspective view of a LED/lens assembly incorporating the baffle of FIG. 33 and the lens mount of FIG. 34 in accordance with a preferred embodiment of the invention,

FIG. 37 is a cross-section of a cluster LED that is an alternative preferred embodiment of the present invention,

FIG. 38 is a cross section of an alternative cluster LED in accordance with a further alternative preferred embodiment of the present invention,

FIG. 39 is a cross-section of an inspection lamp having the cluster LED of FIG. 37,

FIG. 40 is a cross-section of an alternative inspection lamp having the cluster LED of FIG. 38.

FIG. 41 is a cross- section of a light emitting diode in accordance with a first preferred embodiment of the present invention, and

FIG. 42 is a cross-section of a light emitting diode in accordance with an alternative preferred embodiment of the present invention

### MODES OF CARRYING OUT THE INTENTION

In this description, the term “LED source” is used. Unless the context requires otherwise, an “LED source” encompasses a single LED or a plurality of LEDs. LEDs include superluminescent diodes or laser diodes as well as conventional and other light emitting diodes. Laser diodes used in inspection spot lights may be operated in a laser mode or in a no- laser mode.

Also, numerous variants are described. Again, unless the context requires otherwise, such variants apply equally to all of the alternative embodiments described herein. Placing a convex lens forward of a light emitting diode can collimate the light from the light emitting diode into a beam which is narrower and better defined than the beams produced by light emitting diodes. Typically the lens would be forward from the LED by a distance approximately equal to the focal length of the lens so that the beam consists of an image of the front surface of the LED.

Several LEDs, each with a lens, produce beams that can be combined into one bright beam. A light head having several LEDs and associated lenses would be an LED spotlight with several applications. For example, the light head may be combined with suitable circuitry such that it can be powered by 120 or 230 volts AC so that it can be used as an accent light. The light head may be combined with resistors or current regulating circuitry such that it can be powered by batteries so that it can be used as part of a flashlight.

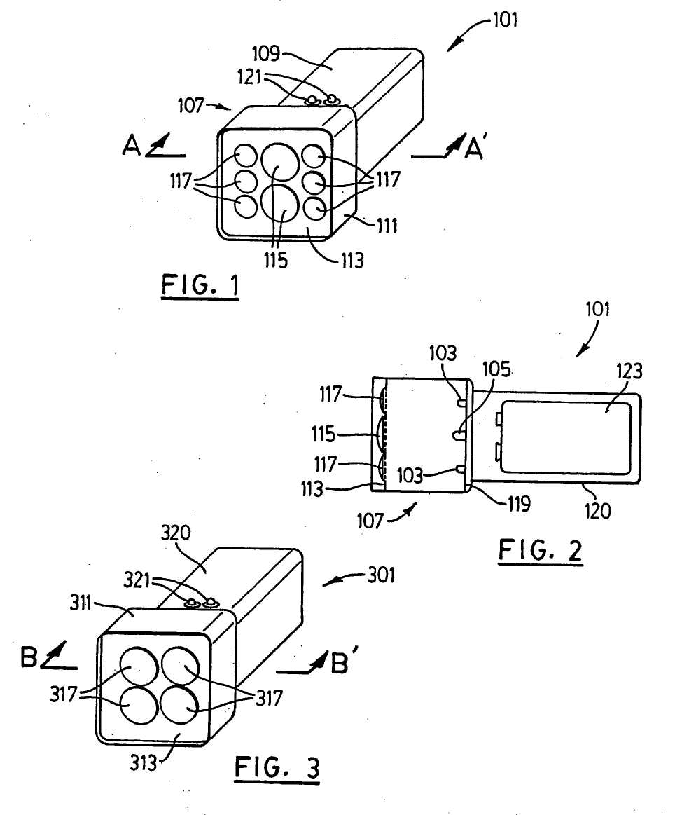

Referring to FIG. 1 and FIG. 2 an inspection lamp 101 has six light emitting diodes 103 that produce ultraviolet radiation and two light emitting diodes 105 that produce blue visible light. The diodes are placed in a configuration similar to the lenses—later introduced as 115, 117—except as otherwise set out herein. The ultraviolet light emitting diodes 103 are of a currently available type having a peak emission wavelength of 370 nanometers with a narrow beam emission permitting the smaller lens. The blue light emitting diodes 105 may be of a preferred type having a peak emission wavelength of approximately 460 nanometers, or of a more easily available type having a peak emission wavelength of approximately 470 nanometers with a wider beam emission and therefore requiring the larger lens. The number of ultraviolet light emitting diodes 103 is greater than the number of blue light emitting diodes 105 because the output power of this type of ultraviolet light emitting diode 103 is typically low compared to that of high brightness blue light emitting diodes 105.

Light emitting diodes of types and quantity different from those described may be used as they are available.

The inspection lamp 101 resembles a flashlight by having a distinct “head” section 107 attached to a distinct handle section 109, with these two sections 107, 109 sharing a common longitudinal axis.

The “head” section 107 has a head casing 111 which contains a forward bulkhead or “lens board” 113 which several lenses (115 and 117) are attached to, and which also contains a rear bulkhead or “light emitting diode board” 119, which the light emitting diodes 103, 105 are attached to. The lens board 113 is mounted sufficiently rearward from the head casing 111 for the head casing 111 to protect the lenses 115, 117 from most accidental impacts. The head casing 111 is attached to a handle section casing 120. These two casing sections 111, 120 may be considered a single part for manufacturing purposes. The casings shown in the Figures are only examples. As will be evident to those skilled in the art, many different shapes and sizes of cases may be used. Casing design may be based on such factors as size, shape, comfort, available components, power source used, cost and visual aesthetics. Mounted to the lens board 113 are two larger lenses 115 used to concentrate the outputs of the two visible blue light emitting diodes 105. Also mounted to the lens board 113 are six smaller lenses 117 used to concentrate and superimpose the outputs of the six ultraviolet light emitting diodes 103 to a target area at a target distance from the lenses 117. In this embodiment, all lenses 115, 117 are of the plano-convex type, with their convex surfaces facing forward, and mounted approximately their own focal lengths forward from the most forward points of their associated light emitting diodes 103, 105.

Other types of lenses, such as bi-convex, meniscus (concave-convex) with similar focal lengths may be used. The plano-convex lens may have advantages in manufacturing and low sphere-related distortions of lenses where the object distance and image distance from the lenses are unequal. An asymmetrical bi-convex or meniscus lens may provide the best distortion characteristics.

It has been found for all embodiments that the target area should be greater than 1 inch wide at a target distance selected from between 5 inches and 3 feet.

For most applications, the target area is limited by the intensity of the LEDs. If the LEDs are sufficiently intense then the beam can be concentrated to a larger target area. If the LEDs are relatively weak then the beam will need to be further concentrated to a smaller target area. For clarity, the beam does not have to fall with the target area for all target distances, only for at least one target distance that is useful for the particular desired leak detection application. For the particular configurations described in this application, it has been found that a target area of approximately 2 to 7 sq. inches provides usable intensity at a usable target distance of between 4 and 20 inches. More intense LEDs or more LEDs could provide a larger target area at a useful target distance.

Lens 115, 117 mounting positions at different distances from their associated light emitting diodes 103, 105 may be favorable in use in some applications. Lens 115, 117 could be positioned at different positions forward of their associated light emitting diodes as an alternative embodiment.

The light emitting diode board 119 is mounted just forward of the rear surface of the head casing 111. Mounted to the light emitting diode board 119 are the two blue light emitting diodes 105 and the six ultraviolet light emitting diodes 103. Alternatively, the rear surface of the head casing 111 may be used as a surface to mount the light emitting diodes 103, 105 to, possibly eliminating the need for the light emitting diode board 119.

Two momentary contact switches 121 are incorporated into this embodiment, with one to be pressed to operate the blue light emitting diodes 105 and the other to be pressed for operation of the ultraviolet light emitting diodes 103. It is permissible to press both switches 121 should it be desirable to have all of the light emitting diodes 103, 105 operating. It is possible that the operator is unaware of which dye is being used, or that the visible light from the LEDs 105 may be useful for illuminating the site being viewed while ultraviolet reactive dyes are being used, or that the radiation from one set of LEDs, for example, 103 may contain a wavelength that the fluorescent dye reacts to, even if to a lesser extent than it reacts to the wavelengths emitted by other group of LEDs 105.

The light emitting diodes are powered by a battery 123 that the handle casing 119 is designed to accept. One terminal of the battery 123 would typically be connected to the cathode terminals of all of the light emitting diodes 103, 105. The other terminal of the battery 123 would typically be connected to one terminal of each of the momentary contact switches 121. The other terminal of each of these switches 121 typically connects to the anode terminals of their associated light emitting diodes 103, 109 through appropriate dropping resistors (not shown in FIG. 1 or FIG. 2; however, an examples for alternate embodiments are shown in FIG. 6 and FIG. 7). Batteries would produce direct current. In low energy and portable small size applications, small dry cell batteries may suffice. For higher energy consumption larger batteries of, for example 12 or 48 volts, may be more practical. In this case, the batteries may have to be external to the light.

There are several ways to properly limit the current flowing through the light emitting diodes 103, 105, including linear current regulator circuits (such as those shown in FIG. 6 and FIG. 7) and switching current regulator circuits. It is also possible to select battery types with sufficient internal resistance not to require dropping resistors or other current limiting means. Current limiting means such as dropping resistors would typically but not necessarily be mounted to the light emitting diode board 119.

Protection can be provided to accept reversed polarities, or to prevent reversed polarities from damaging the LEDs or other lamp components.

Variations of this or other embodiments may be designed to accept power from an external power source, such as an alternating current power source of, for example 120 or 230 volts AC.

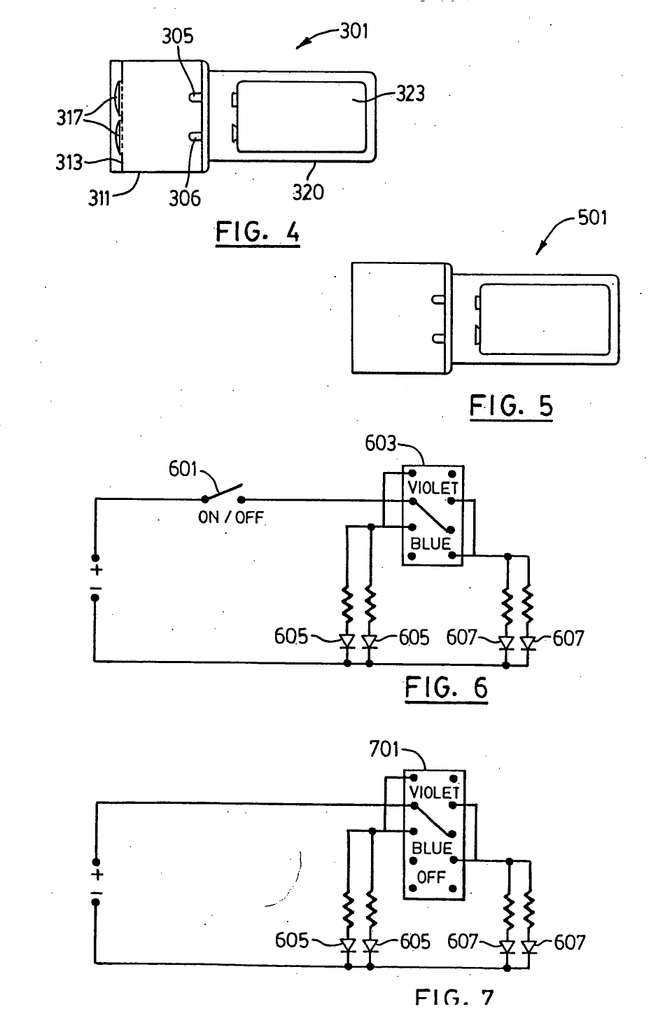

A variation of this embodiment having no lenses or lenses for only some of the light emitting diodes may be useful with light emitting diodes having adequately narrow beam characteristics. Referring to FIG. 3 and FIG. 4 show an alternative inspection lamp 301 has two light emitting diodes 305 that produce blue visible light and two light emitting diodes 306 that produce violet visible light. Again, the LEDs each pair are lined up with one another in a similar manner to the later introduced lenses 317, except as otherwise set out herein. The blue light emitting diodes 305 are of a high output type having a peak emission wavelength in the range of 440 to 475 nanometers. The violet light emitting diodes 306 are of a high output type having a peak emission wavelength of approximately 405 nanometers. Alternatively, the shorter wavelength light emitting diodes 306 may be of an ultraviolet type having a peak emission wavelength of 395 nanometers or less while the longer wavelength light emitting diodes 305 would have a peak emission wavelength anywhere from 405 to 475 nanometers.

The lamp 301 resembles the lamp 101 by having a distinct head casing 311 and handle casing 320 sharing a common longitudinal axis so as to resemble a “flashlight”. These two casing sections 311, 320 may be considered one part for manufacturing purposes.

A forward bulkhead 313 or “lens board” has mounted to it four identical plano-convex lenses 317. These lenses 317 concentrate and superimpose the outputs of two blue light emitting diodes 305 and two violet light emitting diodes 306.

The blue and violet pairs of light emitting diodes 305, 306 can be activated by pressing associated momentary contact switches 321.

The handle casing section 319 accepts a battery 323 that is used to power the light emitting diodes 305, 306.

Again, current limiting means (not shown) may be dropping resistors or current regulation circuitry. Alternatively, the battery may be of a type having high enough internal resistance or other characteristics such that current regulation means is not necessary. Again, variations of this embodiment may be designed to accept power from an external power source.

Referring to FIG. 5, a further alternate inspection lamp 501 does not use concentrating lenses, and is otherwise the same as lamp 301. In this case, the advantages of LEDs with different wavelengths are retained, and, provided the LEDs are of sufficient intensity, the resulting beam will continue to be usable in leak detection.

As intimated earlier, in any of the embodiments, it can be advantageous to utilize narrow beam LEDs. In this description a narrow beam LED is said to produce a concentrated beam. As indicated previously, a beam originating from near the focal plane of a lens will also result in a concentrated beam. When a concentrating lens is used in combination with a concentrated beam from an LED then more of the energy from the LED can be made to pass through the lens. It can be particularly useful to use a concentrated beam from an LED when a concentrating lens is not used. By directing more of the energy from the LED directly at the area to be viewed, the resulting fluorescence will be increased when compared to a wider beam from an equally powerful source. The beam area at the target site is selected to provide a useful target area for leak detection. If the beam area is too small then portions of the system being tested may be inadvertently missed. If the beam area is too great then the intensity of the radiation at the target site may be insufficient.

If it is desired to use a particularly narrow beam LED, or an LED that has over convergent internal optics then diverging lenses may be used to create a target area sufficiently large to be usable.

Many alternate embodiments are possible, including, for example, those having only one switch to control all light emitting diodes. As another example, Embodiments of this invention may have any switching means commonly used in flashlights, such as switching means where switching is accomplished by rotating the head section.

Another embodiment could include one very high power blue light emitting diode, such as a maximum current rating of 350 milliamps, along with several lower power light emitting diodes that produce visible violet light or ultraviolet radiation.

Both visible violet and ultraviolet light emitting diodes may be used in addition to the blue light emitting diode, such that light emitting diodes of more than two types are used.

Alternative configurations can include any number of light emitting diodes depending on the specifications and the desired application of the lamp. When using LEDs emitting significant radiation of the same wavelength as a fluorescent dye may emit, it can be desirable to have a switch or combination of switches (such as switches 121) that allow selection of individual LEDs or groups of LEDs.

Referring to FIG. 6 and FIG. 7, other alternative switch configurations may be used, for example, a momentary switch 601 can be used in combination with an LED selector switch 603. The LED selector switch 603 selects between either LEDs 605 or LEDs 607, or both. When the momentary switch 601 is activated the currently selected LEDs will be energized. A two-pole three position switch 601 is suitable where two groups of LEDs 605, 607 are used. As an alternative example, a single switch 701 can be used to perform both the selection and activation function. A two-pole four position switch 701 is suitable where two groups of LEDs 605, 607 are used.

The switches 603, 701 are 2-pole multi-position slide switches. The switch diagrams show only the fixed contacts within the switches 603, 701. The moving part of each switch 603, 701 (not shown as is often done in a slide switch wiring diagram), within the left column and repeated in the right column, connects two vertically adjacent contacts.

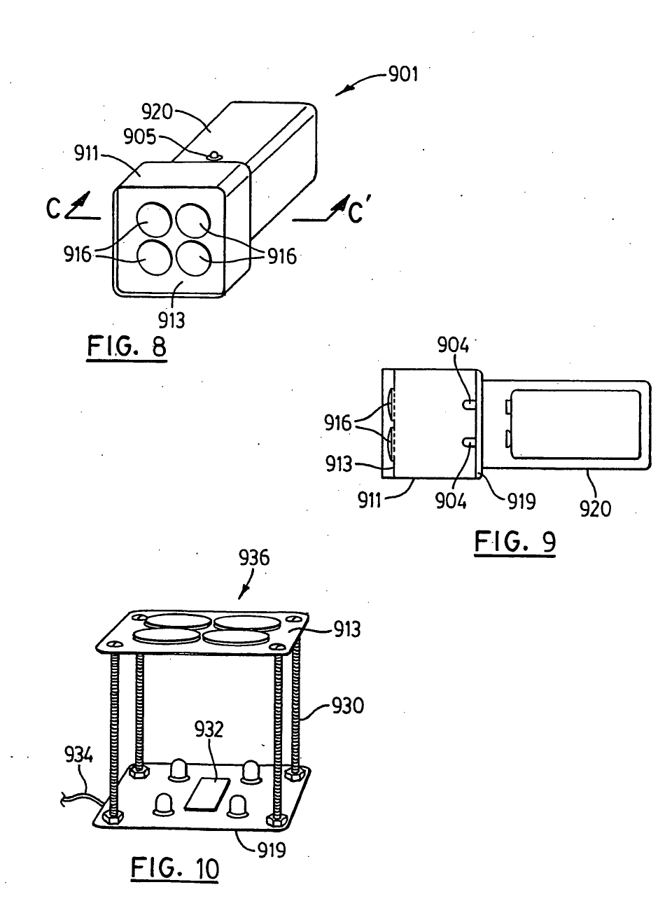

Referring to FIG. 8 and FIG. 9 an inspection lamp 901 has four light emitting diodes 904 having a peak wavelength of anywhere from 370 to 475 nanometers. The light emitting diodes 904 may have significantly different peak wavelengths so as to excite a variety of fluorescent materials. The lamp has a single switch 905, and is otherwise similarly configured to the lamps 101, 301, with a distinct head casing 911 and handle casing 920.

A forward bulkhead 913 or “lens board” has mounted to it four identical plano-convex lenses 916. These lenses 916 concentrate and superimpose the outputs of the light emitting diodes 904.

It may be important to note that in some circumstances, particularly if there is sufficient intensity, wavelengths below 395 nanometers may be harmful. Safety precautions may be necessary.

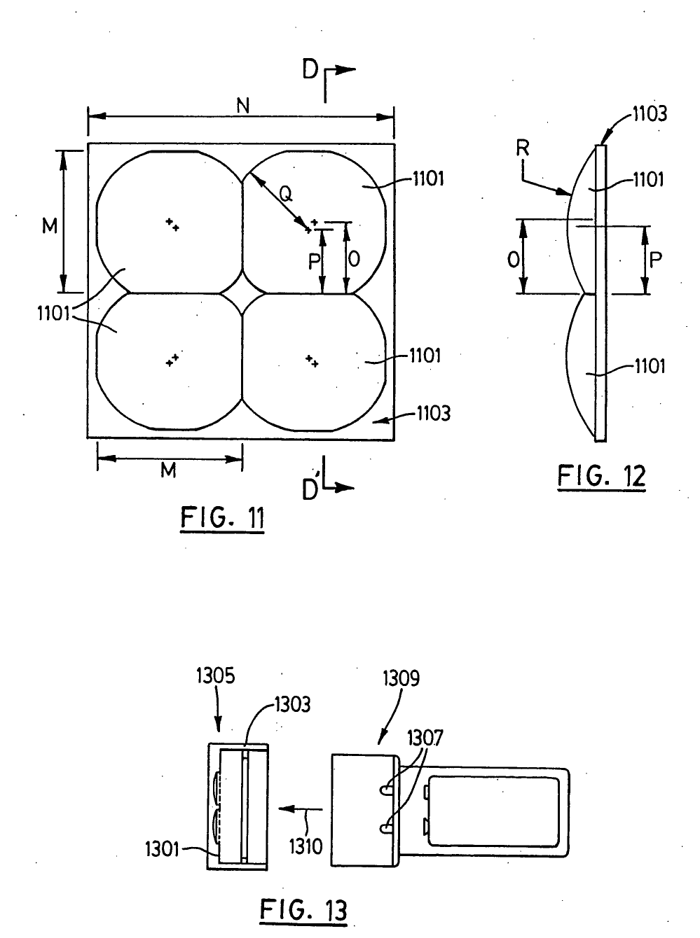

Referring to FIG. 10, as an example, a lens board 913 and a LED board 919 are maintained in fixed position with respect to one another by spacers 930. Current limiting circuitry 932 is also contained on the board 919 and wire 934 is provided for connection to a battery, not shown. The other connection to the battery is by way of a button contact on the underside of the board 919. The lens board 913 and LED board 919 form lens/LED assembly 936.

A lens/LED assembly, such as the assembly 936 can replace the reflector and/or the bulb of an ordinary flashlight, not shown, in order to convert the flashlight to an inspection lamp suitable for selection of fluorescent materials. The dimensions of the assembly 936 may need to be altered in order to fit within the flashlight. For example, many flashlights are round; so, the shape of the boards 913, 919 could be made circular. All such modifications fall within the spirit and scope of the invention, the preferred embodiments of which are described herein.

In the presently preferred embodiments of the invention, the lenses are forward of the tips of the light emitting diodes. The distance from the tips of the light emitting diodes is slightly greater than the focal length of the lenses, such that each lens forms a distinct circular image of the light emitting diode at a distinct distance forward from the lenses. The centers of the lenses are separated from each other by a distance slightly less than the distance between the centers of the light emitting diodes, such that lines from the centers of each of the light emitting diodes through the centers of their associated lenses converge at the same distance forward from the lenses that the forward portions of the bodies of the light emitting diodes are focused.

Alternatively, the lenses may be placed forward from the light emitting diodes at a distance from the tips of the light emitting diodes to the lenses that is approximately the focal length of these lenses so as to produce a smaller and more intense spot at the point of convergence.

Referring to FIG. 11 and FIG. 12, lenses 1101 may be formed in a lens assembly 1103 from a single moulded piece of suitable transparent material. The lenses 1101 in lens assembly 1103 are in the shape of squares with rounded comers to reduce the spacing between their centers compared to circular lenses having the same area.

Each of lenses 1101 may have its principal point displaced to one side of the center of its area so as to have some prism character. This would be done to form beams whose axes intersect at some specific distance forward of the lens assembly if each emitting diode is centered to the rear of the center of the area of each lens and the axis of each light emitting diode passes through the center of the area of each lens.

It is recognized that in any of the embodiments described herein, there may be radiation from an LED that passes through a lens other than the lens with which the LED is associated. This can result in secondary images of the LED, typically spaced around and separate from the superimposed images. Although it may be aesthetically distracting, this effect will not be detrimental to the use of the lamp. There are a number of ways to avoid this “cross-talk” between LEDs and non-associated lenses. For example, concentrated beams from LEDs could be used or separators could be placed between the LEDs so that non- associated lenses cannot “see” other LEDs.

Referring again to FIGS. 11 and 12, in the preferred embodiment of the lens assembly 1103 width M of a lens 1101 is 13 mm, the overall width N of the lens assembly 1103 is 27.4 mm, the distance O from the centerline of the lens assembly 1103 to center between edges of each lens 1101 is 6.5 mm, the distance P from the centerline of lens assembly 1103 to center of curvature of each lens 1101 is ⁶ mm, the radius Q is 7.2 mm, and the radius of curvature R of each lens assuming a refractive index of 1.5 is 11.1 mm. Those skilled in the art will recognize that other combinations of parameters can be used in accordance with the principles described herein.

Another embodiment could be a lens assembly to be added to an existing flashlight having multiple light emitting diodes suitable for causing visible fluorescence of fluorescent materials.

Referring to FIG. 13, the lens assembly 1301 could be contained in a housing 1303 to form a lens adapter 1305. In the preferred embodiment, the adapter 1305 is formed from a resilient material such as rubber, and the adapter 1305 slips over the head of an existing multiple LED 1307 lamp 1309 (as indicated by arrow 1310). The adapter 1305 has stops 1309 to assist in positioning the adapter 1305 to properly place the lens assembly 1301 in relation to the LEDs 1307. Different adapters 1305 will likely be necessary to match the particular configuration of each lamp 1309. Alternate means for removably attaching the adapter 1305 to lamp 1309 will be evident to the those skilled in the area, including, for example, a tight fitting stiff plastic for a manual fit.

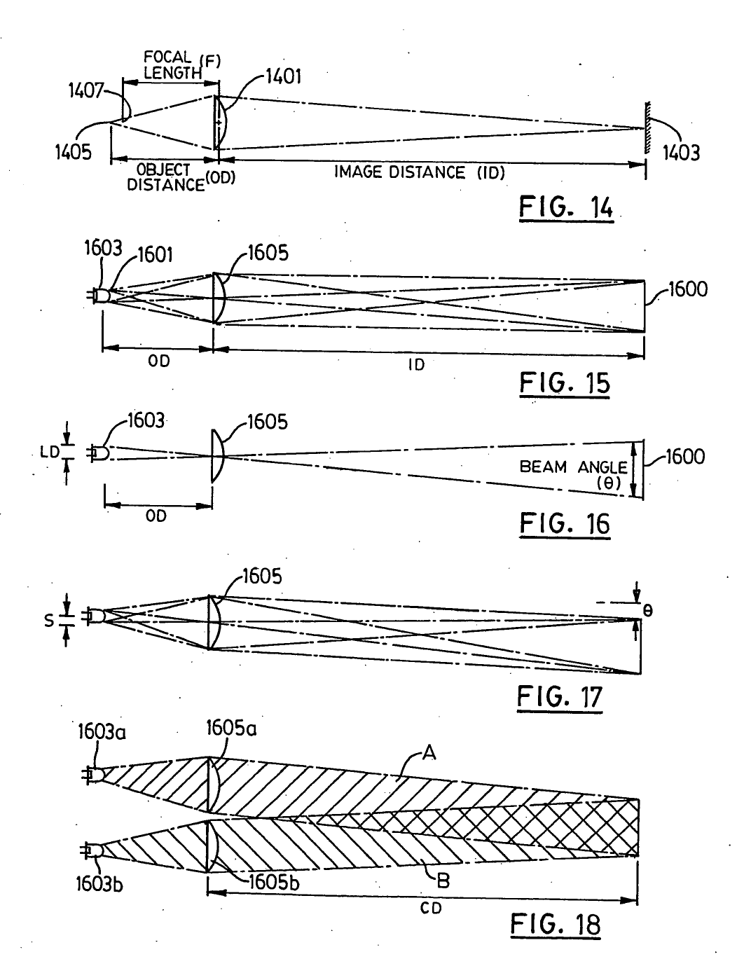

Referring to FIGS. 14-18, further details of possible relationships between the lenses and LEDs will now be discussed.

Referring to FIG. 14, a convergent lens 1401 can form an image 1403 of an object 1405. If the object 1405 is at the focal point 1407 of the lens 1401 (on one side of the lens), or at a distance (OD) from the lens 1401 equal to the focal length (F) of the lens 1401, then an image 1403 is formed at the other side of the lens 1401 at infinite distance (ID) from the lens 1401. By movement or focus of the lens 1401, the image 1403 is well-enough formed at all far distances and at any point beyond this distance the image is larger and blurred or out of focus. There is a relationship among object 1403 distance (from the lens 1401), image distance (ID) (from the lens 1401), and focal length (F) of the lens 1401:

$$\frac{1}{object distance} + \frac{1}{image distance} = \frac{1}{focal length}$$

In the lamp 901, the lenses 916 have a focal length of 35 mm, and they are placed 40 mm from the LEDs 904 (by theory) to produce a focussed image of the front surfaces of the LEDs 904 at 280 mm from the lenses 916.

Each lens of a multi-lens multi- LED flashlight, embodiments of which are described herein, makes good use of only the one LED with which it is associated. Each LED-lens combination concentrates the beam from the LED to form a “spotlight”. These “spotlights” operate optically independent of each other but are aimed onto a common target and thus “superimposed”—in the case of lamp 901, 280 mm forward of the lenses was chosen as the common target distance from the lenses.

Referring to FIG. 15 ray paths involved in formation of an image 1600 of the front surface 1601 of an LED 1603 are shown. The LED 1603 is separated from lens 1605 by a distance slightly greater than the focal length of the lens 1605 and the image 1600 is formed at some distinct distance from the lens 1605. The image 1600 of the front surface 1601 of the LED 1603 is an attractive bright circle, assuming that all portions of the front surface 1601 of the LED 1603 are passing rays utilized by the lens 1605. The lamp 901 has four independent LED-lens combinations, each form a circular image onto the same area at a design “target distance” of 280 mm from the lenses 916.

Referring to FIG. 16, rays from the edges of the LED 1603 are shown passing through the center of the lens 1605 to the edges of the image 1600, to illustrate the beam angle as a function of LED diameter (LD) and the distance (OD) from the LED 1603 to the lens 1605. Theoretically exactly, the tangent of half the beam angular diameter is equal to the ratio of LED radius (½ LD) to its distance (OD) from the lens 1605. As a useful approximation, the beam diameter in radians will usually be the ratio of LED diameter (LD) to the distance (OD) from the LED 1603 to the lens 1605. Multiplying this figure by 57.3 gives an approximate beam angular diameter in degrees.

Flashlights have a typical beam diameter of only a few degrees while many of the latest high output LEDs have a typical beam diameter of nominally 15 degrees. It has been found that a beam angular diameter less than 15 degrees is desirable for a flashlight-like sort of inspection lamp. A beam diameter of 7-8 degrees produces a spot width of about 1.5 inches at 1 foot. In the lamp 901, the LED diameter is 5 mm and the LEDs are approx. 40 mm from the centers of the lenses. Twice the arctangent of (half of 5/40) is approx. 7.2 degrees. Thus, the beam has an angular diameter close to this where it is best-defined (best-focused and converged) approx. 280 mm from the lenses of the lamp 901.

Referring to FIG. 17, shifting the LED 1603 slightly to one side (S) of the axis of the lens 1605 causes the resulting beam to form at a slight angle from the axis of the lens 1605. In the preferred embodiment of the lamp 901, the four lenses 916 are centered approx. 17.5 mm from each other vertically and horizontally, or 8.75 mm from the lens assembly's common axis vertically and horizontally.

The beams projected from each lens 916 converge onto each other at 280 mm from the lenses 916, so their centerlines deviate from the centerline of the lamp 901 so as to shift 8.75 mm vertically and horizontally from the lens axes per 280 mm of distance forward of the lenses 916.

To achieve this, the LEDs 904 are mounted in positions displaced outward from the lens axes both horizontally and vertically by (8.75*40/280) mm from the lens axes, or 1.25 mm both vertically and horizontally from the lens axes, or approx. 1.77 mm from the axes of their associated lenses 916 on lines passing through the lens assembly center, the lens axes, and the LEDs 904.

To achieve this for the preferred embodiment, the LEDs 904 are mounted in positions displaced outward from the lens 1605 axes both horizontally and vertically by (8.75*40/280) mm from the lens assembly axis or 1.25 both vertically and horizontally from the axes of their associated lenses 916, or approx. 1.77 mm total diagonal distance from the axes of their associated lenses 916.

Referring to FIG. 18, two LED-lens combinations 1605a/1603a, 1605b/1603b with LEDs offset from the axes of their associated lenses produce two beams A, B that coincide at a specific distance (CD) from the lenses 1605. Not shown in FIG. 18 is rays explaining how the beams are best-defined at the same distance. However, design of a flashlight having multiple “independent units” each consisting of an LED 1603 and a lens 1605 would preferably have the beams best-defined (focused images of the front surfaces of the LEDs) at the same distance at which their centerlines intersect.

Although it is not strictly necessary to have a focused image, it minimizes light wasted into a less illuminated “blur zone”. Another advantage of a beam with sharp edges is that a sharp beam edge makes it easier to determine whether or not an area being inspected is being illuminated by the beam.

The above explains how a multi-lens multi-LED flashlight produces a beam that is attractive and impressive at a specific distance from the lenses. It is desirable to have as wide a range of useful “working distance” as possible.

Generally, a shorter lens focal length compared to the “typical working distance” or “design working distance” results in the beams being well-defined over a wider range of distances. However, a shorter focal length results in a wider beam. This can be countered by use of smaller diameter LEDs to the extent such smaller LEDs are available. The “usual size” of LED is 5 mm (often known in the USA as “T1-¾”), with the next-most-common size being 3 mm (often known in the USA as “T1”).

Another consideration is that the smaller the lens area required to utilize the beam is, the less the beam loses definition at distances other than the target area. Smaller size LEDs lose most of their advantage here, since they are generally not available in beam width as narrow as that of narrow beam versions of larger LEDs. The main effect of the relationship between LED size and narrowest available beamwidth is to largely set a preferred minimum lens diameter of approx. 13 mm to produce a roughly 7-8 degree beam.

However, the shorter focal length of lenses to be used with smaller diameter LEDs is advantageous in having individual beams from each lens retaining good definition over a wider range of distances—to the extent that suitable LEDs are available in the smaller size. One more consideration is making the lines passing through the center of the LEDs and the “principal point” of its associated lens to have the least possible angle of convergence. This makes the beams largely coincide with each other over a larger range of distances. One way to make the beam axes have a reduced angle of convergence is to use smaller diameter lenses. However, the lenses must be large enough to catch most of the output beams of the LEDs. Narrower beam LEDs are advantageous here.

It should be noted that most 5 mm LEDs have significant light output to 7.5-8 degrees from the LED axis, or in other words have a 15-16 degree beam. 5 mm LEDs with substantially narrower beamwidth have significant output outside their nominal beam area, often as a “secondary ring beam” 15-18 degrees in angular diameter. 3 mm LEDs have nearly proportionately wider beams, and permit only a small reduction in lens diameter.

One more consideration is that the angular diameter of each beam exiting a lens should exceed the angle between axes of the beams. Achieving this assures that all individual beams merge into each other at least partially for all distances from about half the “design target distance” to infinite distance.

The angle between beam centers, in degrees, is approximately 57.3 times the ratio of lens spacing (between centers of lenses in opposite comers of the lens assembly) to design target distance from the lens. This figure for the preferred embodiment of lamp 901 is 57.3 times (25/280) or approx. 5.1 degrees. Since this figure is less than the approx. 7.2 degree diameter of the individual beams, there is some area covered by all beams at all distances greater than the design target distance. If this is true, then generally it is also true that all distances as short as approx. half the design target distance can be illuminated by all of the individual beams.

As noted above with respect to FIG. 18, usual convex lenses 1605 in a usual configuration require the LEDs 1603 to be offset vertically and horizontally from the axes of the lenses 1605.

A disadvantage of this is that the LEDs 1603 must be slightly tilted to be aimed at the centers of the lenses 1605 (which is done in the lamp 901) or the lenses 1605 must be large enough to capture “off-center” LED beams.

If the lenses 1605 have a “prismatic effect” of bending a ray passing through the center of the area of the lens, then the LED 1603 can be mounted directly behind the lens 1605 with the LED 1603 and lens 1605 having a common axis parallel to that of an inspection lamp. The lens 1605 would then form a beam which exits the lens 1605 at an angle from the axis of the lens 1605.

One way to achieve this is to use a plano-convex lens having the center of curvature offset slightly from a “centerline” parallel to the axis of the entire “flashlight unit” and passing through the center of the area of the lens. One possible arrangement is that each lens is 16.8 mm wide and the LEDs coincide with lens axis/centerlines 16.8 mm apart but the centers of the curvature of the curved lens surfaces are only 14.7 mm apart. LEDs 40 mm from such lens elements would form beams bent after exiting from these lens elements so as to coincide with each other 280 mm from the lenses. Referring to FIG. 12, one can see how the center of curvature of each lens 1101 is offset slightly from the center of the area of the lens 1101.

As otherwise described herein, a lens specification in an inspection lamp having a lens forward of each LED can be determined as follows:

1. For a given target distance and beam width of a design, the LED's distance from the lens would be the LED's diameter times the ratio of target distance to beam width at the target distance.

2. The lens focal length should be:

1/(1/(target distance from lens)+1/(LED distance from lens))

3. A lens should be barely wide enough to capture the beam produced by its LED. Multiply the LED's distance from the lens by twice the tangent of half the beam angle, and add to this the LED's diameter. (Or determine experimentally how wide a lens is required to capture the LED's beam at the distance from the LED that the lens is to be located at.) Most 5 mm narrow beam LEDs have a beam width, including any significant secondary beam features, of approx. 15-18 degrees. Most 3 mm narrow beam LEDs have an overall beamwidth of approx. 25-28 degrees. These are the presently preferred LEDs.

4. Then comes the offset between LED axis and lens axis to make the beams converge:

a) In the prototype shown in FIG. 10, ordinary convex lenses (with optical center coinciding with the center of the area of each lens) are used and the centers of the LEDs are spaced slightly further apart than the centers of the lenses such that rays from the lens centers pass through the lens centers unbent and converge upon the center of the target area. The LEDs would be angled to aim them at the lens centers.

b) A variation of this embodiment would have the lens centers closer together than the LED centers, but the LEDs are not aimed at the lens centers. The lenses would then need to be wide enough to capture the beams from the LEDs. This means that the lens radius needs to exceed the beam radius by the offset between the LED's axis and the axis of the lens in order for the lens to capture the beam.

c) Lenses with optical center offset from the midpoint of the lens can be used. Each LED can be directly behind the midpoint of the lens, but the optical center (center of curvature of curved surfaces) is offset from the midpoint of the lens (or lens element) so that a ray passing through the midpoint of the lens is bent. FIG. 12 shows a molded assembly of such lens elements.

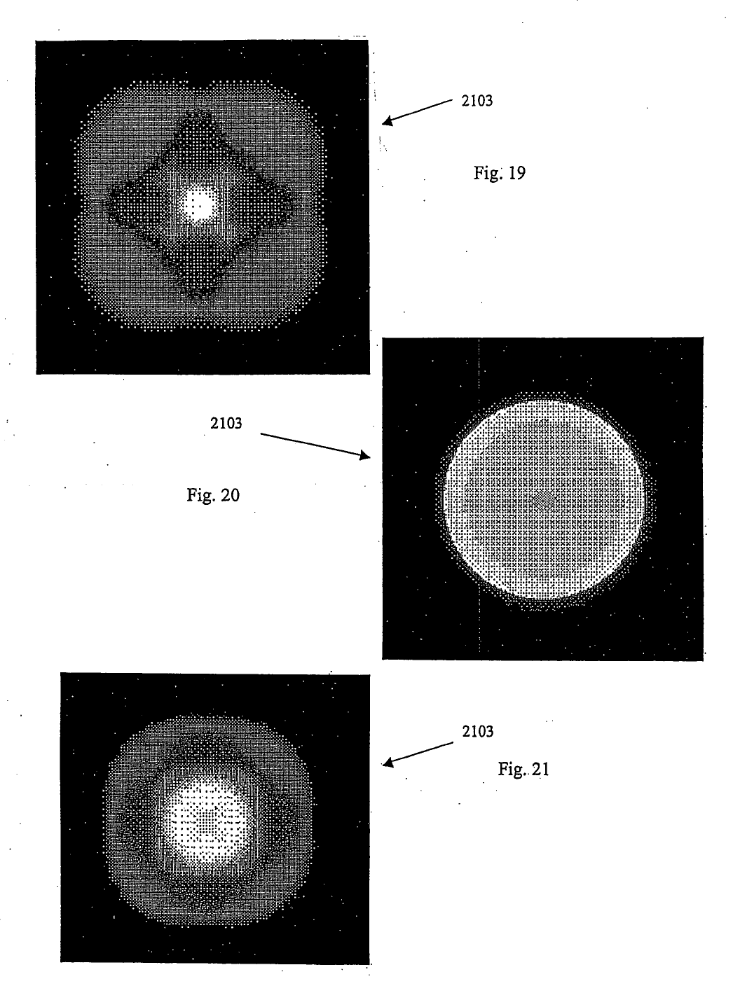

Referring to FIGS. 19-21, the benefits of concentrating and superimposing lenses can be seen.

Referring to FIG. 19, at a target distance of 6 inches a beam 2103 formed with lamp 901 is concentrated and partially superimposed.

Referring to FIG. 20, at 11 inches, the beam 2103 is well-defined (focused, concentrated and superimposed) in a given area. At this distance, the beam width was approximately 36 mm.

Referring to FIG. 21, at 20 inches the beam 2103 remains concentrated in a limited area.

Although the beam is substantially superimposed, convergence is not perfect at this distance. Beam divergence spreads the beam to an ever increasing area which reduces the beam intensity.

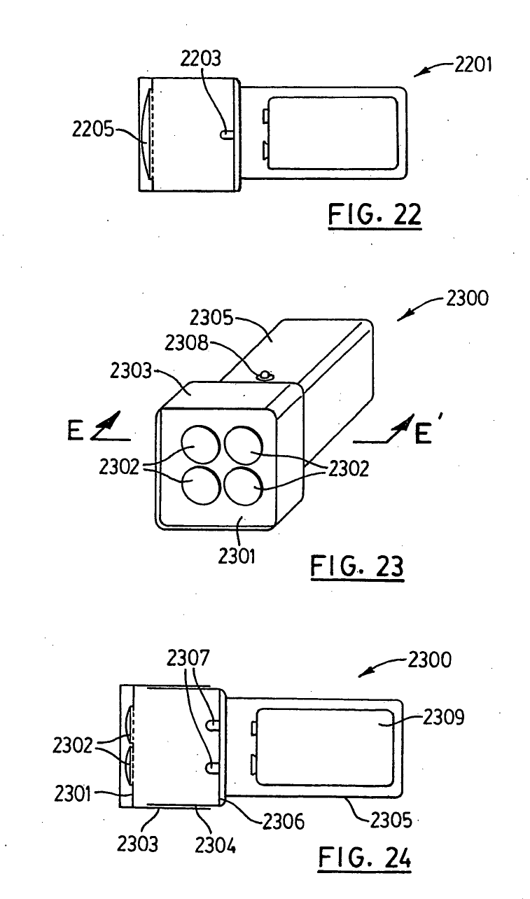

Referring to FIG. 22, a light 2201 has a single LED 2203 and a single converging lens 2205. The LED 2203 has a peak wavelength that is useful with a leak detection fluorescent dye, for example any of the LEDs previously mentioned could be used. The LED 2203 and lens 2205 combination is configured similarly to any one of the LED and associated lens combinations described previously; however, it is not necessary to offset the LED 2203 from the axis of the lens 2205, or to offset the principle point of the lens 2205, as the beam does not need to be superimposed on other beams. The light 2201 provides a more intense, concentrated beam than a single LED 2203 without such a lens. The light 2201 can be more compact than if multiple LEDs and lenses are used. The light 2201 can have useful battery life operating from a single “watch” type of battery.

For LEDs having particularly wide beams it is desirable to use the shortest possible focal length lens such as a plastic fresnel or pair of simple lenses. Some high power LEDs, for example 350 millliamps, are only available in wide beam angle, for example approximately 100 degrees. In a preferred embodiment of this configuration the diameter of the lens should approximate the focal length of the lens.

LEDs typically have a rated operating life of approximately 100,000 hours. Leak detection lamps are typically operated sporadically for relatively short periods. All embodiments can be configured to drive LEDs at a greater wattage then their rated wattage (“overdrive”). This will reduce the lifetime of the LEDs, but will increase the intensity of the emitted radiation.

It may be appropriate to allow the lenses in a LED inspection light to be movable. For example, moving or focusing a lens assembly will permit some adjustment of beam convergence. The amount of adjustment in a multiple lens assembly may be limited since reduction of the distance from the LEDs and the lens assembly may eventually cause the lenses not to capture all of the light from each LED. As a further example, adjusting the distance between the LEDs and the lenses can adjust the distance at which the beams are in focus.

It is also possible to create inspection lights with multiple LEDs where only some of the LEDs have lenses. The LEDs not associated with lenses should be separated from LEDs associated with lenses by a sufficiently large distance (typically at least a lens diameter) so that lenses do not block the beams of LEDs that do not have lenses in front of them.

Alternative embodiments for use in generating visible light will now be described. As stated previously, the features and characteristics of the alternative visible light embodiments may be applied to the previously described embodiments, as desired.

Referring to FIGS. 23 and 24, a spot light in the form of a visible light flashlight 2300 is similar in layout to the lamp 901 of FIGS. 8 and 9. LEDs 2307 are mounted onto an LED board 2306, which is either mounted to or an integral part of the inner head casing 2304. The inner head casing is attached to a handle casing 2305. The inner head casing and the handle casing may be comprised in one piece for manufacturing purposes.

An outer head casing 2303 fits over the inner head casing. The outer head casing 2303 has a lens board 2301 mounted within it. The lens board 2301 has lenses 2302 to collimate (substantially superimpose to a target area at a target distance from the lenses) the light from the LEDs 2307 into beams narrower and better defined than the LEDs produce without lenses. The LEDs 2307 are powered by a battery 2309. The LEDs 2307 typically require current limiting means (not shown), although it may be possible to produce the invention with batteries having internal resistance high enough to avoid the need for current limiting. The LEDs 2307 would typically be controlled by a switch 2308 that may be of the momentary contact pushbutton variety. The switch may be of another variety such as a slide switch or a push on/push-off pushbutton.

The outer head casing slides over the inner head casing. This provides means to adjust the distance between the LEDs 2307 and the lenses to adjust the width and degree of concentration of the beam. This also provides means to make the beam best-focused at different distances from the flashlight.

The LEDs 2307 in this embodiment and other embodiments of the present invention may all be white LEDs 2307 or they may be colored LEDs 2307 selected to have their outputs combine to form light which is acceptable as white light

An embodiment having colored LEDs 2307 can have one blue LED 2307a, one green LED 2307b, and two red LEDs 2307c. It is often found that when combining red, green and blue LEDs 2307 to produce white light, the number of red LEDs 2307c must exceed the number of green LEDs 2307a and the number of blue LEDs 2307b since red LEDs 2307c are often not as efficient in producing red visual response as green and blue LEDs 2307a,b are in producing their respective green and blue visual responses.

Use of red, green and blue LEDs 2307 can have an advantage over white LEDs 2307 for three reasons:

LEDs 2307 have a tendency to specialize in producing light in a specific region of the spectrum. White LEDs 2307 are typically blue LEDs having a phosphor added to them to convert some of the blue light to a band of wavelengths from green to red. Due mostly to the losses in the phosphor, white LEDs 2307 are less efficient than non-white LEDs 2307.

If a combination of red, green and blue LEDs 2307 is used, the spectrum of the combined output of the LEDs 2307 has more red and green content and less yellow content than is present in the spectrum of white LEDs 2307. The greater red and green spectral content increases the illumination of red and green objects. Yellow objects in general are illuminated by a combination of red and green light as effectively as they are by yellow light. A flashlight 2300 having spectral content richer than usual in red and green wavelengths at the expense of yellow wavelengths will illuminate red and green objects more brightly than usual for the given total light intensity, with minimal compromise in ability to illuminate objects of other colors such as yellow. This may be a useful characteristic of embodiments of the present invention that are used as flashlights or as accent lights.

The green LEDs 2307a can produce light mostly at wavelengths close to 507 nanometers, which is the wavelength at which night vision works best A flashlight 2300 rich in wavelengths near 520 nanometers can work better for night vision than a flashlight 2300 with white LEDs 2307 which produce less light at wavelengths near 500-520 nanometers.

Combinations of colored LEDs 2307 other than red, green and blue can be used to produce white light and can be used in embodiments of the invention, although the ability to illuminate colored objects would generally be less than that obtained by using red, green and blue LEDs 2307. For example, blue and yellow LEDs 2307 can be combined to produce light that appears white. Likewise, red and blue-green can be combined to produce light that appears white. In addition, more than two different colors can be used and they could be other than red, green and blue. For example, light that appears white can be obtained by combining appropriate quantities of blue, green, and any color from red to orangeish yellow. Other examples to produce essentially white light include LEDs of yellow, green and blue, or yellow, turquoise and magenta.

Flashlights 2300 producing a color other than white may be found to be desirable. Specifically, flashlights 2300 producing essentially yellow light may be found to be desirable. The LEDs 2307 in such a yellow flashlight may all be yellow or they may be green and red to achieve brighter illumination of red and green objects than is possible with a flashlight using yellow LEDs 2307. Various embodiments of a yellow version of the present invention may have orange and green LEDs 2307, or may have yellow LEDs 2307 combined with other colors that can be combined to result in essentially yellow light.

Combinations of colored LEDs 2307 may be selected to achieve high spectral content in green, blue-green and blue wavelengths favorable to scotopic vision (night vision). Such combinations are not limited to combinations that produce white light

The LEDs 2307 may be mounted with their centers directly behind their associated lenses 2302 so that the beams formed by the lenses 2302 are parallel and merge into each other best at long distances from the flashlight 2300. Alternatively, the LEDs 2307 may be mounted with centers slightly further apart than their corresponding lenses 2302 are so as to make the beams produced by each LED 2307 converge at some specific finite distance forward of the flashlight 2300.

Lenses 2302 with their optical centers displaced from the midpoints between their edges can be used. This permits mounting the LEDs 2307 directly rearward of the midpoints between the edges of their associated lenses 2302 and achieving beams which are non-parallel such that the beams converge upon each other at a finite distance forward of the lenses 2302. The lenses 2302 may be part of a one-piece molded lens assembly 2301.

The lenses 2302 would have a focal length large enough compared to the LED 2307 diameter to produce an adequately narrow beam. The beam formed by each of the lenses 2302 would have a width in radians approximately equal to the ratio of LED 2307 diameter to the focal length of the lens 2302 when the beam is best focused. Best focus of the beam is typically achieved by having the distance between the lenses 2302 and their associated LEDs 2307 approximately equal to the focal length of the lenses 2302 so as to form images of the front surfaces of the LEDs 2307.

The lenses 2302 would normally be as small as possible while large enough to capture the beams produced by their associated LEDs 2307. The minimum lens 2302 diameter for utilizing most of the light from the LEDs 2307 would be, approximately, the LED 2307 diameter plus the focal length times the width of the beams produced by the LEDs 2307 in steradians. LEDs 2307 of the narrowest available beam width would normally be selected to minimize the required size of the lenses 2302. LEDs 2307 may have alternate beam widths and lenses 2302 of alternate sizes.

In presently preferred embodiments of the invention, the lenses 2302 have a width of 14 mm and a focal length of 24-25 mm and the LEDs 2307 are 3 mm in diameter and have a beam width of approximately 25 degrees. This results in a beam approximately 3/24 or ⅛ steradian wide, or approximately 7 degrees wide. A beam of such width can be achieved using 5 mm LEDs 2307 with a beam width of approximately 15 degrees and lenses 2302 with a width of 16 millimeters and a focal length of 40 millimeters.

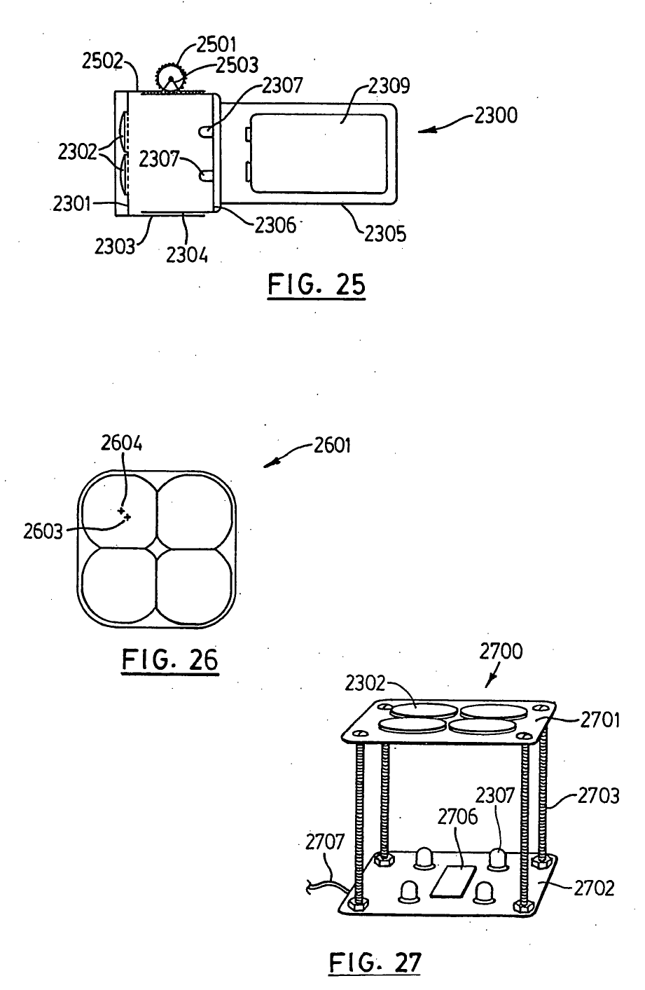

Movement of the lenses 2302 with respect to the LEDs 2307 may be useful to adjust the width and degree of focus of the beam produced by the flashlight 2300, or to make the beam as narrow and/or as focused as possible at a specific distance from the flashlight 2300. Flashlight 2300 has four LEDs 2307 and four associated lenses 2302. A different number of LEDs 2307 and associated lenses 2302 may be used. An embodiment having seven LEDs and associated lenses may be particularly advantageous. This allows for LEDs to be arranged in an attractive hexagon pattern with one LED at the center in a circular flashlight head. Referring to FIG. 25, the flashlight 2300 has beam characteristics that are adjustable. The distance of the lenses 2302 from the LEDs 2307 can be adjusted by rotating a toothed thumbwheel 2501 that meshes with a toothed track 2502 on the inner head casing 2304. The thumbwheel 2501 rotates within a thumbwheel holder 2503 that is attached to the outer head casing 2303. Rotating the thumbwheel 2501 moves the outer head casing 2303 with respect to the inner head casing 2304. Since the lenses 2302 are attached to the outer head casing 2303 and the LEDs 2307 are fixed to the inner head casing 2304, moving the outer head casing 2303 with respect to the inner head casing 2304 adjusts the distance between the LEDs 2307 and their associated lenses 2302.

Alternative embodiments, not shown, may utilize a round outer head casing and a round inner head casing which are threaded such that rotating the outer head casing about a common axis of the head casings can achieve adjustment of the distance between the lenses and their associated light emitting diodes. Useful degrees of rotation of the outer head casing with respect to the light emitting diodes would normally be limited to ones which place the lenses as directly forward from their light emitting diodes as possible.

Referring to FIG. 26 a 1-piece molded lens assembly 2601 is similar to lens assembly 1103 of FIGS. 11 and 12. The optical centers (for example, 2603) of individual lenses 2302 may be slightly displaced from the midpoints 2604 between edges of the lenses 2302 and towards the center of the lens assembly 2601. This allows placing LEDs 2307 directly behind the midpoints between edges of their associated lenses 2302 while achieving beams that, with each other and at a finite distance forward of the lenses 2302, form these convergent beams.

Alternatively the lenses 2302 may have their optical centers at the midpoints between their edges and/or directly forward of their associated LEDs 2307. The beams formed by the lenses 2302 may be parallel and may be found to adequately converge at various finite distances forward from the lenses 2302. As a further alternative, the lens assembly 2601 may have lenses 2302 with optical centers midway between the edges of the lens elements and the LEDs 2307 may have center-to-center spacing greater than that of the lenses 2302 so that the beams produced by the lenses 2302 converge at a finite distance forward of the lens assembly 2601.

Referring to FIG. 27 a light head (lens\LED assembly) 2700 is similar to lens\LED assembly 936 of FIG. 10. The head 2700 may be part of a flashlight 2300 or used as a spot light, not shown, in fixed applications, for example as an accent light or a reading light. The light head 2700 consists of a lens board 2701 and LED board 2702 attached to spacing means 2703 which maintain the proper distance between the lens board 2701 and the LED board 2702. The spacing means 2703 shown are screws, although a head casing, not shown, can be the spacing means 2703.

The other embodiments described herein may also be utilized for fixed spot light applications. In this case, “fixed” refers to situations where the spot light is not generally moved after initial set-up. Such light may have significant heat and energy savings over lights currently used in such situations. As an example, many accent lights are typically used in jewelry stores. Once the lights are put in position, the lights are not typically moved on a regular basis. Lenses 2302 are attached to the lens board 2701 and LEDs 2307 are mounted on the LED board 2702. The lenses 2302 and the lens board 2702 may be replaced by a one-piece molded lens assembly 2601 like that shown in FIG. 26.

Current limiting circuitry 2706 may be attached to the LED board 2702. The light head 2700 receives power from a cable 2707 consisting of two wires.

The current limiting circuitry 2706 may be located elsewhere and is not necessarily attached to the structural parts shown. In some embodiments current limiting circuitry 2706 may not be necessary, such as in flashlights 2300 using batteries with internal resistance which limits the current flowing through the LEDs 2307 to a value which is not harmful to the LEDs 2307. Embodiments can include lens 2302 center-to-center spacing greater than the LED 2307 center-to-center spacing if this is found to achieve useful beam characteristics. The lenses 2302 in the presently preferred embodiments of the invention are plano-convex with the planar surface of such lenses 2302 facing the LEDs 2307. Embodiments of the present invention may use other convergent lenses such as biconvex lenses and convex meniscus lenses and converging fresnel lenses. Embodiments of the present invention may have lens combinations to serve the purpose of each lens 2302. Compound lenses may be optimum in embodiments using LEDs 2307 that produce very wide beams.

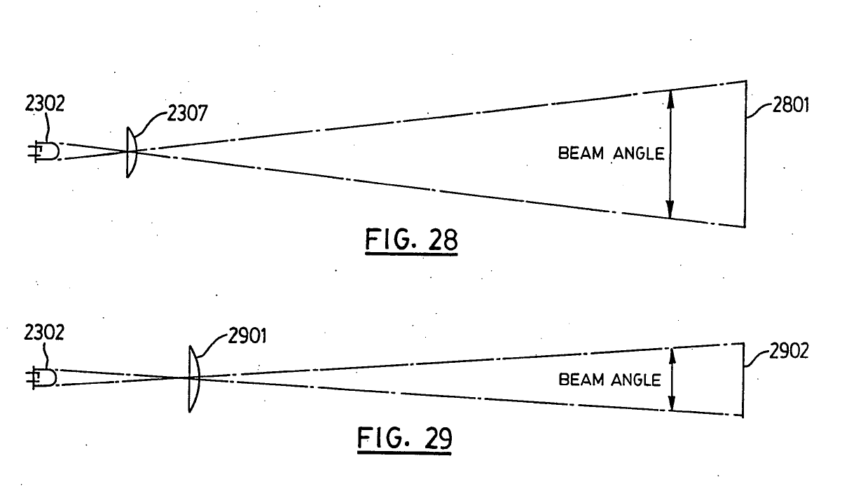

Referring to FIG. 28 and 29, the relationship of focal length of lens 2302 and diameter of LED 2307 are illustrated along with the size of the image 2801 that they produce. Some applications will require that the same image size must be produced at a distance that is twice that of the first design. This can be accomplished by using a lens 2901 whose focal length is twice that of lens 2302 with LED 2307 and doubling the spacing between the lens 2901 and LED 2307. The resultant spot of light or image 2902 will then be both smaller and brighter than the results obtained at this increased distance from LED 2307 and lens 2302.

Embodiments of the invention may have “zoom lenses” or other lens arrangements to simulate lenses of adjustable focal length so as to provide adjustability of the width of the beams formed by the lenses.

Alternatively, a flashlight may be supplied with different removable lens assemblies such that one lens assembly can be removed from the flashlight and a lens assembly having lenses of a different focal length can be attached to the flashlight, with the different lenses having an appropriately different distance from the LEDs 2307 according to their focal length.

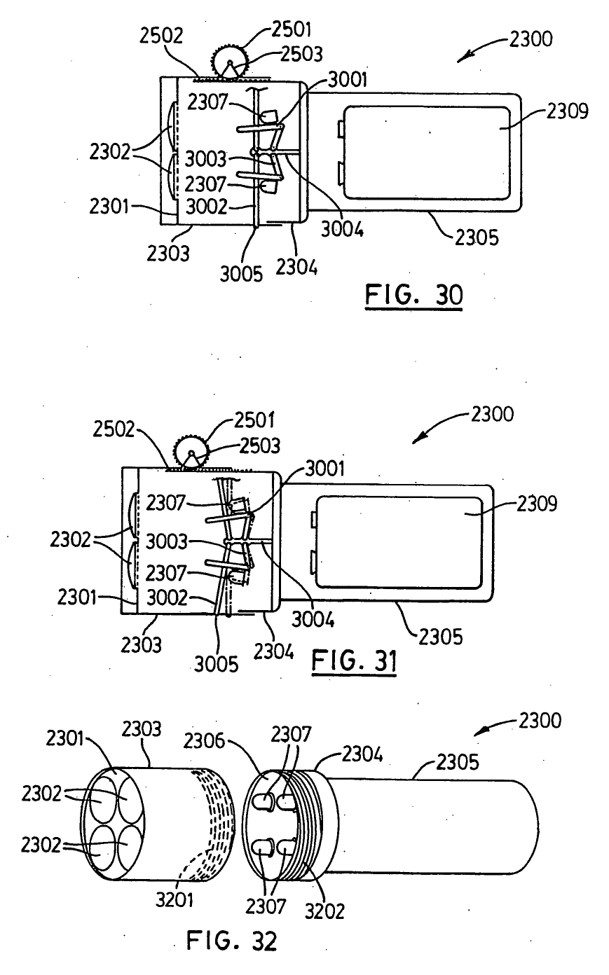

Referring to FIG. 30, a visible light flashlight 2300 having adjustable beam characteristics and similar to the one shown in FIG. 25 is able to adjust the distance between the LEDs 2307 along with the distance between the lenses 2302 and the LEDs 2307.

The LEDs 2307 are mounted to outer movable connecting rods 3001 as opposed to being mounted to a fixed LED board. The outer movable connecting rods 3001 are connected to forward movable connecting rods 3002 and rear movable connecting rods 3003. The forward and rear connecting rods 3002 and 3003 are attached to a central axial connecting rod 3004 which is fixed to the inner head casing 2304. The forward connecting rods 3002 pass through holes 3005 in the outer head casing 2303. Some of the holes 3005 and portions of some of the forward connecting rods 3002 are not shown in order to show the toothed thumbwheel 2501 and the toothed track 2502.

The forward connecting rods 3002 and the outer connecting rods 3001 should be placed where they would not block light from the LEDs 2307.

The inner ends of the rear connecting rods 3003 are significantly more forward than the outer ends of the rear connecting rods 3003, while the forward connecting rods 3002 are more nearly perpendicular to the axial connecting rod 3004. Because of this, the LEDs 2307 are moved further from the axis of the flashlight 2300 as the outer head casing is moved forward. In addition, the outer connecting rods 3001 become less parallel to the axial connecting rod 3004 as the outer head casing is moved forward so that the LEDs 2307 remain nearly aimed at the optical centers of the lenses 2302.

As the outer head casing 2303 is moved forward, the beams formed by the lenses 2302 are not only best-focused at a distance closer to the flashlight 2300, but also nearly enough converging at the same distance. Although the arrangement shown in FIG. 30 does not perfectly accomplish convergence of the beams at the distance which they are best defined at, this arrangement can acceptably achieve adjustability in a target distance at which the beams are acceptably focused and merged together.

Variations of this arrangement and other arrangements may be found which provide a single adjustment for both beam convergence and beam focus such that the target distance can be varied with the beams acceptably converging and in focus at the target distance.

Referring to FIG. 31, the adjustable version of the flashlight 2300 shown in FIG. 30 is adjusted for a shorter target distance and the beams formed by the lenses 2302 can be acceptably coinciding and converged at this shorter distance.

The outer head casing is in a more-forward position with respect to the inner head casing 2304, compared to its position shown in FIG. 30. As the outer ends of the forward connecting rods 3002 move forward along with the outer head casing 2303, the central portion of the forward connecting rods 3002 do not move with respect to the inner head casing as much as outer ends of the forward connecting rods 3002 do. Since the outer connecting rods 3001 are connected to the central portions of the forward connecting rods 3002, they and the LEDs 2307 attached to them move less with respect to the inner head casing 2304 than the outer head casing 2303 and the lenses 2302 do. In this arrangement, the spacing between the lenses 2302 and the LEDs 2307 increases as the outer head casing 2303 is moved forward with respect to the inner head casing 2304.

As the outer head casing is moved forward, the junctions between the outer connecting rods 3001 and the rear connecting rods 3003 move outward from the axial connecting rod 3004 as the angle between the axial connecting rod 3004 and the rear connecting rods 3003 decrease. The distance from the axial connection rod 3004 of the junctions between the outer connecting rods 3001 and the forward connecting rods 3002 is more constant since the forward connecting rods 3002 are shorter and more nearly perpendicular to the axial connecting rod 3004 than the rear connecting rods 3003 are.

With forward movement of the outer head casing 2303 causing the rear junction points of the outer connecting rods 3001 to move further from the axial connection rod 3004 but not causing the forward junction points of the outer connection rods to move much, the central or rear portion of the outer connection rods 3001 can be further from the axial connection rod 3004 and the outer connection rods 3001 can be less parallel to the axial connection rod 3004. This achieves position of the LEDs 2307 further from the axis of the flashlight 2300 and also achieves an increase of the angle between the axes of the LEDs 2307 and the axis of the flashlight 2300. To an acceptable extent this can achieve aim of the LEDs 2307 at the lenses and at a target at a shorter distance from the lenses 2302 as the lenses 2302 are moved further from the LEDs 2307 so that they would form a focused image of the forward surfaces of the LEDs at the shorter target distance.

The previous positions of the forward connecting rods 3002, the rear connecting rods 3003 and the light emitting diodes 3004 are shown to illustrate their movement Accordingly, the scope and spirit of the present invention includes embodiments with separate adjustments for convergence of the beams towards each other and for focusing of the beams.

Referring to FIG. 32, the flashlight 2300 can be adjusted by rotating the outer head casing or lens collar 2303 about the inner head casing 2304. The outer head casing 2303 and the inner head casing 2304 are threaded with threads 3201 and 3202 respectively so that rotation of the outer head casing 2303 with respect to the inner head casing 2304 changes the distance of the lens board 2301 with respect to the LED board 2306.

The outer head casing 2303 is shown completely unscrewed from the inner head casing 2304 to better show the outer head casing threads 3201 and the inner head casing threads 3202. Useful degrees of rotation will be limited to those which place each of the lenses 2302 nearly enough directly forward of one of the LEDs 2307.

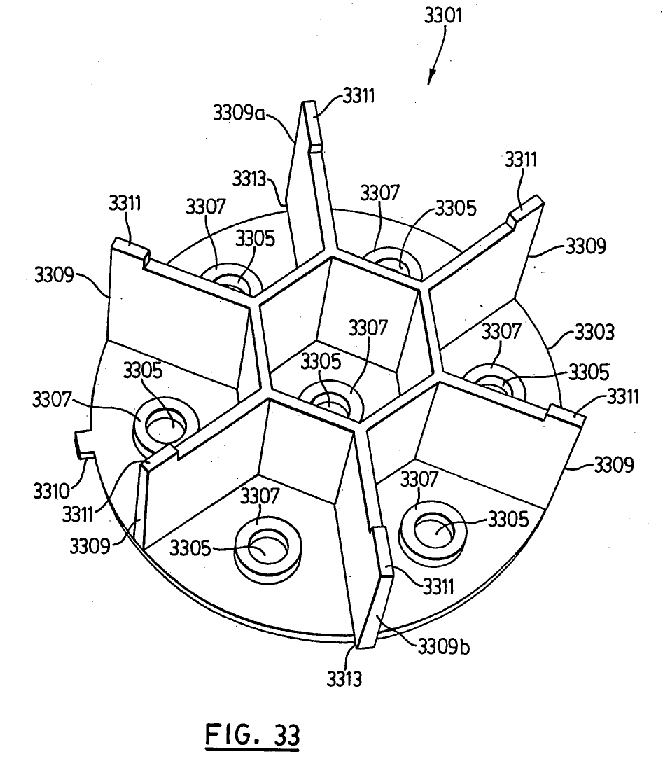

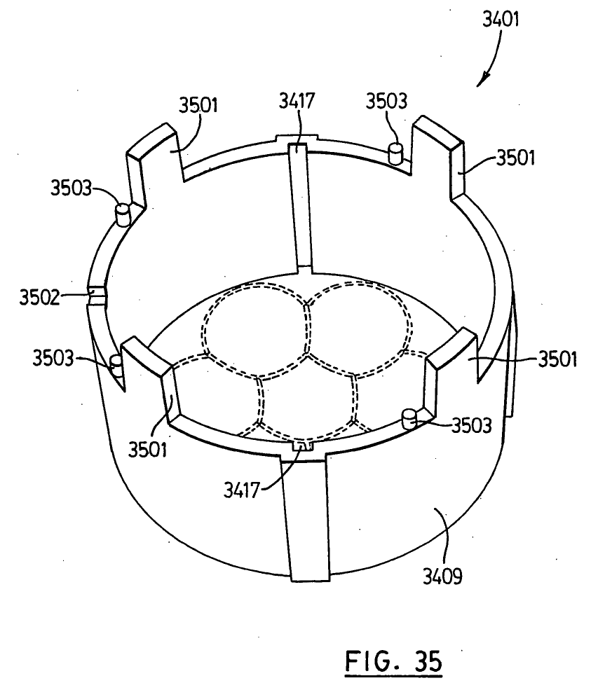

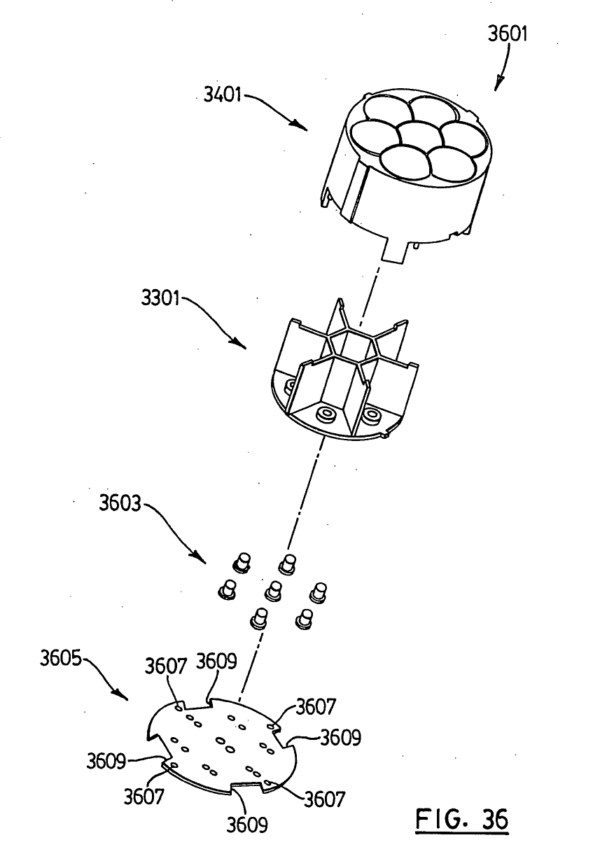

Referring to FIGS. 33 through 36, an LED/lens assembly 3601 is made up of a baffle 3301, lens mount 3401, LEDs 3603 and printed circuit board 3605.

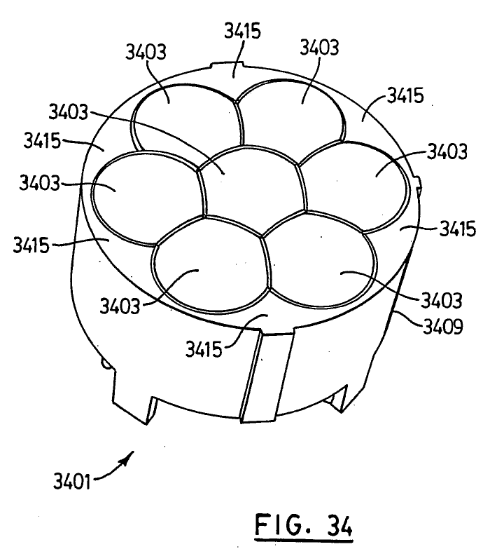

The lens mount 3401 has seven lenses 3403 (FIG. 34). Six of the lens 3403 are mounted in a circular pattern with one central lens.

Correspondingly, there are seven LEDs 3603. The LEDs 3603 are mounted on the board 3605 with six LEDs 3603 evenly separated at an equal radius from center of the board 3605. One LED 3603 is mounted at the center of the board 3605. The board 3605, baffle 3301 and lens mount 3401 are circular to fit a circular profile light casing, not shown As will be evident to the those skilled in the art using the principles described herein, other profiles may be used. The relationship of LEDs and lenses is designed as previously set out herein, taking into account the number of LEDs and lenses used. The baffle 3301 holds the LEDs 3603 and the lens mount 3401 (and thus the lenses 3403) in the desired relationship. The baffle 3301 is also an example of a separator that prevents “cross-talk” between an LED 3603 and a non-associated lens 3403 as referred to previously herein.

The baffle 3301 has a circular base 3303 of smaller diameter then the board 3605. The base 3303 has seven circular openings 3305 spaced to receive the LEDs 3603. The openings 3305 serve to correctly space the LEDs 3603 for proper alignment with the lenses 3403. It is preferred to use a baffle or like means to space the LEDs 3603 as a LED/printed circuit board combination does not typically provide spacing within the tolerances required for alignment with the lenses 3403.

The openings 3305 have an annular extension 3307. The extension 3307 provides extra depth for proper axial alignment of the LEDs 3603.

Extending from the base 3303 are separators 3309 that separate the LEDs 3603 from one another and prevent light from one LED 3603 from passing through a lens 3403 with which it is not associated. For the particular configuration chosen the separators 3309 form a honeycomb-like pattern.

Extending outwardly from the base 3303 is a tab 3310.

The lens mount 3401 has a tubular body 3409. Enclosing one end of the tubular body 3409 is the lenses 3403. Extending from the other end of the tubular body 3409 are legs 3501. At the same end there is a notch 3502 through the tubular body 3409. The internal diameter of the body 3409 is slightly larger than the base 3303. Thus the baffle fits into the lens mount 3401 until the tab 3310 snuggly engages the notch 3502. At the same time the separators 3309 meet the lens mount 3401. The separators 3309 have extensions 3311 that engage the lens mount 3401 beneath spaces 3415 between the outer ring of lenses 3603, while not scratching the lenses 3603. This maintains a desired distance between the LEDs and their associated lenses. The lens mount 3401 and the lenses 3603 may be formed from a single piece of plastic. Alternatively, they may be formed from multiple pieces of plastic that are fused to form a single integrated mount with lenses.

There is also a pair of opposing slots 3417 in the body 3409. Two opposing separators 3309a and 3309b extend beyond the base 3303 to form rails 3313. The rails fit within the slots 3417 for axial alignment and to prevent rotation of the baffle 3301 with respect to the lens mount 3401.

The tab 3310 and notch 3502 combination acts to orient the baffle 3301 and lens mount 3401 the same way with respect to one another at all times. Although it is intended that the baffle 3301 and the lens mount 3401 will each be symmetrical, it is possible that when manufactured they will not be symmetrical. Provided that the errors are matched in the baffle 3301 and lens mount 3401, some errors may be overcome provided that the baffle 3301 and lens mount 3401 are oriented the same way with respect to each other at all times.

Pins 3503 also extend from the tubular body 3409. There are corresponding holes 3607 in the board 3605 that engage the pins 3503. The pins 3503, sometimes referred to as heat stakes, are made from plastic. They extend through the holes 3607. The portion of the pins 3503 extending through the holes 3607 is heated to cause it to flatten out, thus retaining the board 3605 in fixed relationship to the lens mount 3401.

The legs 3501 extend through cut-outs 3609 in the board 3605. The legs 3501 are used as stand-offs from a light casing, not shown.

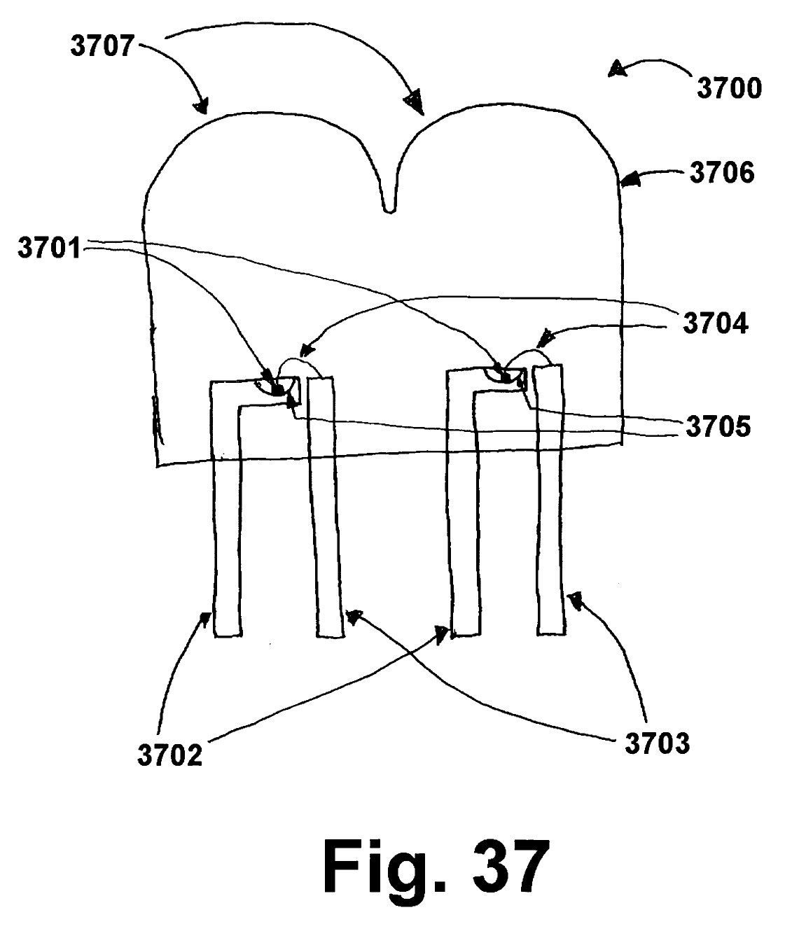

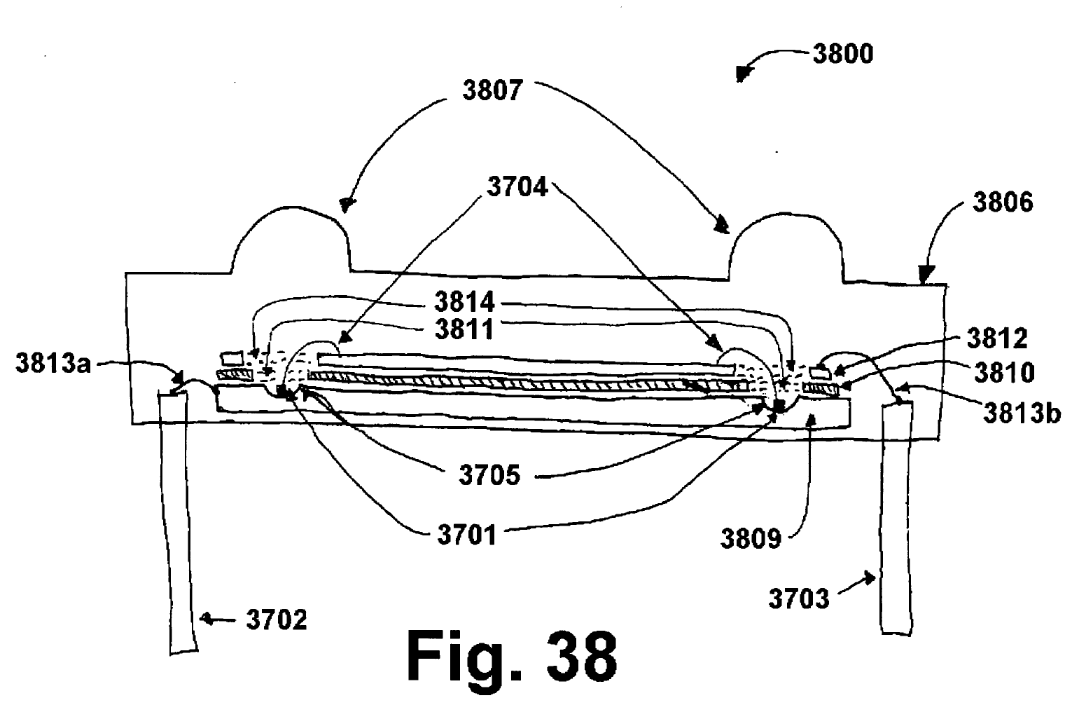

Referring to FIG. 37, a cluster LED 3700 has two or more LED chips 3701, each of which is attached to a cathode lead 3702. The cluster LED 3700 might also be thought of as a “LED cluster lamp” since a 1-piece LED component with solderable leads or other connections within a single package is often called an “LED lamp”. Each cathode lead 3702 has a die cup 3705 that reflects forward some of the light emitted by the LED chips 3702. Near each cathode lead 3702 is an anode lead 3703. A bonding wire 3704 connects each chip 3701 to its corresponding anode lead 3703.

If the LED chips 3701 are made with a conductive substrate material such as silicon carbide, then they are usually electrically connected to the cathode leads 3702 just by being attached to them. If the LED chips are made with a nonconductive substrate material such as artificial sapphire, then an additional bonding wire or similar device (not shown) is typically required to connect the negative terminal of each LED chip 3701 to its associated cathode lead 3702. The encapsulating package 3706 has domed regions 3707 forward of the LED chips 3701 for optical purposes such as collimating the emitted radiation into beams. The cluster LED 3700 may be designed such that the individual beams formed by each of the domed regions 3707 converge at a specific distance forward of the cluster LED 3700. Alternatively, the cluster LED 3700 can be designed to produce beams which are parallel to each other.

The domed regions 3707 may have circular boundaries, polygonal boundaries, or boundaries of a different shape. The domed regions 3707 may or may not be identical in the shapes of their boundaries.

The domed regions 3707 may be separated from each other or they may be adjacent to each other. Some or all of the domed regions 3707 may or may not have common boundaries with each other.

The cluster LED 3700 may contain additional parts such as resistors, regulating circuitry, or flashing circuitry.

The cluster LED 3700 may have all of the cathode leads 3702 or all of the anode leads 3703 comprised in a single piece of metal. For example, the anode leads 3702 may be comprised in a single sheet of sheet metal having holes to fit around the LED chips 3701 and their associated cathode leads 3702.

All of the cathode leads 3702 and all of the anode leads 3703 may be connected to or comprised at least in part in two sheets of metal. In such a case, it is anticipated that one of these two sheets of metal would have holes corresponding to each of the LED chips 3701. An example of this configuration is further discussed below with respect to the LED 3800 of FIG. 38. Other arrangements are possible for making connections to the LED chips 3701.

It can be seen that in addition to various other applications, the cluster LED may be used as an LED source for spot light or inspections lamps, such as those discussed previously. The cluster LED can replace the plurality of LEDs behind lenses. Alternatively, the cluster LED may incorporate all or part of the lensing function as discussed above through the use of domed regions that focus, collimate and/or merge radiation from the LED chips 3701.

Although it may be very convenient to use a single piece cluster LED incorporating its own focusing, collimating and/or merging method, utilizing domed regions that first provide round images of the radiation emitting from the LED chips 3701, and then focusing, collimating and or merging the round images, provides a beam that has a smooth edge. This is aesthetically pleasing, and can be useful in applications that benefit from improved contrast at the edge of the beam.

Referring to FIG. 38, a cluster LED 3800 incorporates multiple LEDs in a single encapsulation. The LED 3800 incorporates the metal anode and cathode sheets mentioned previously. The domed regions 3807 of the encapsulating package 3806 are smaller than those in the cluster LED 3700 of FIG. 37 and may be used, for example, with lenses (not shown) that are placed forward of the domed regions 3807.

For intense narrow beams, the larger domed regions 3707 of FIG. 37 are best used as lenses that collimate the radiation into a beam without additional optics, and work well when they are larger since a larger size is necessary to collect the radiation from a greater distance necessitated by a longer focal length of such lenses/domes. Also, longer focal length results in less magnification and accordingly a narrower and more intense beam. It has been found that a beam width of 9-10 degrees is preferred for inspection lamp applications.

The small domed regions 3806 as shown in FIG. 38 are better for imaging by a lens forward of each of them, and should be smaller so that images of them are smaller and more intense. A further variation of the cluster LED 3800 typically requiring additional optics can be made entirely lacking the domed regions 3807.

The LED chips 3701 are attached to a single piece of sheet metal 3809 that is being used as the cathode connection. A cathode lead 3802 is connected to the cathode sheet 3809 by a wire 3813a. The LED chips 3701 would be connected in parallel with each other. One way to do this is by placing an insulating sheet 3810 over the cathode sheet 3809. The insulating sheet 3810 has holes 3811 to keep it from covering the LED chips 3701 and connections to them. Bonding wires 3704 connect the positive terminals of the LED chips 3701 to an anode sheet 3812. The anode sheet 3812 has holes 3814 over the insulating sheet's holes 3811 so that it does not cover the LED chips 3701. An anode lead 3803 is connected to the anode sheet 3812 by a wire 3813b.

The cathode sheet 3809 would typically but not necessarily have die cups 3705 to reflect forward some of the radiation produced by the LED chips 3701.

Other arrangements are possible for making connections to the LED chips 3701. Variations of this embodiment of the present invention can have some features of the cluster LED 3700 of FIG. 37 and some features of the cluster LED 3800 of FIG. 38. For example, a variation of the cluster LED 3800 may lack the cathode sheet 3809 and anode sheet 3812 but have a lead arrangement like that of the cluster LED 3700 of FIG. 37.

A cluster LED 3700 of FIG. 37 or 3800 of FIG. 38 may have the LED chips 3701 centered directly behind the optical centers of the domed regions 3707, 3807. Alternatively, any of the LED chips 3701 may have their centers at locations other than directly behind the optical centers of the domed regions 3707, 3807. For example, if the centers of the LED chips 3701 are spaced slightly farther apart than the optical centers of the domed regions 3707, 3807 are, then beams of radiation formed from each of the LED chips 3701 will merge into each other at a finite distance forward of the cluster LED 3700, 3800.

It is anticipated that a desirable number of LED chips 3701 and associated domed regions 3707, 3807 in the cluster LED 3700 or the cluster LED 3800 would be three, four, seven, nineteen or thirty- seven so as to fit in a circular package in a space efficient manner. Alternatively, the number of LED chips 3701 and associated domed regions 3707, 3807 may be suitable for making a square pattern. However, any number two or more of LED chips 3701 and associated domed regions 3707, 3807 may be used.

Although the cluster LED 3700 of FIG. 37 or the cluster LED 3800 of FIG. 38 may have any number of LED chips 3701 and associated domed regions 3707, 3807 that is two or more, it is anticipated that a desirable number of LED chips 3701 and associated domed regions 3707, 3807 would be three, four, seven, nineteen or thirty seven.

Cluster LEDs like the cluster LED 3700 of FIG. 37 or the cluster LED 3800 of FIG. 38 can be useful for making LED inspection lamps. Such cluster LEDs may have a peak wavelength of less than 425 nanometers. Such cluster LEDs can be useful for some LED inspection lamps if the peak wavelength is longer, such as near 450 or near 460 nanometers.

In any case, it may be found beneficial for some LED inspection lamps to use a cluster LED resembling the cluster LED 3700 of FIG. 37 or the cluster LED 3800 of FIG. 38 and having a longer, bluish peak wavelength anywhere from 425 to 500 nanometers.

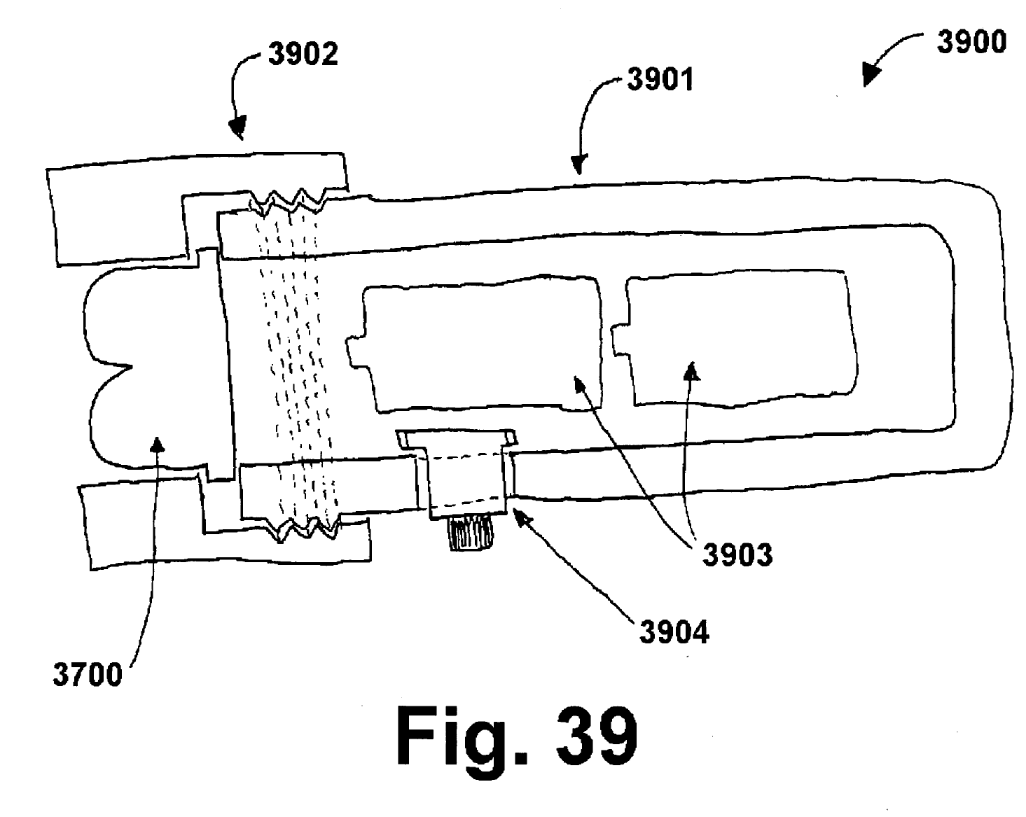

Cluster LEDs resembling the cluster LED 3700 of FIG. 37 or the cluster LED 3800 of FIG. 38 can be made to produce light that is white or otherwise more suitable for illumination purposes than for causing fluorescence of fluorescent materials. Such a white version of the cluster LED 3700 or 3800 may have the LED chips 3701 producing blue light and being coated or covered by a phosphor that absorbs some of the blue light and fluoresces light that mixes with the blue light in order to produce white light Such fluorescence may include, for example, a narrowband yellow, a broad band yellow, a broad band that extends from green to red, or at least mostly red and green or green and either orange or an orangish shade of yellow. Cluster LEDs producing light that is white or otherwise more suitable for illumination purposes than for causing fluorescence of fluorescent materials but otherwise resembling the cluster LED 3700 of FIG. 3 or the cluster LED 3800 of FIG. 38 may be found useful for making flashlights. Referring to FIG. 39, an alternative embodiment of the present invention is an inspection lamp 3900 that has a cluster LED 3700 like that of FIG. 37. This inspection lamp 3900 resembles a flashlight and typically comprises an outer casing 3901, a front capture ring 3902, one or more batteries 3903, and a switch 3904 and has electrical connections (not shown). Current limiting circuitry such as a dropping resistor (not shown) is usually used and included. The current limiting circuitry may alternatively be a linear current regulator, a switching current regulator, or a boost converter that has current limiting or power limiting characteristics. Further alternatively, an inspection lamp 3900 can be made to work without current limiting circuitry, although it is widely preferred to use current limiting circuitry.

The inspection lamp 3900 may further comprise additional parts such as charging circuitry, a charging jack, a heatsink for the cluster LED 3700, a loop for a lanyard, a lanyard, and/or one or more indicator lamps or indicator displays such as a battery status indicator. The outer casing 3901 may or may not be comprised in a single piece of material. The outer casing 3901 may or may not be made at least in part of plastic. The outer casing 3901 may or may not be made at least in part of metal. The outer casing 3901 or a portion thereof may be used for heatsinking purposes to dissipate heat from the cluster LED 3700.

The inspection lamp 3900 may, as shown, resemble a flashlight by having its outer casing 3901 in the form of a head section and a handle section sharing a common axis. Other arrangements are possible, including but not limited to having the head axis offset from the handle axis, having the head axis not parallel to the handle axis, having the handle bent or in the form of a pistol grip, or having a separate head and handle connected by a flexible gooseneck. A variation can be made with more than one cluster LED 3700.

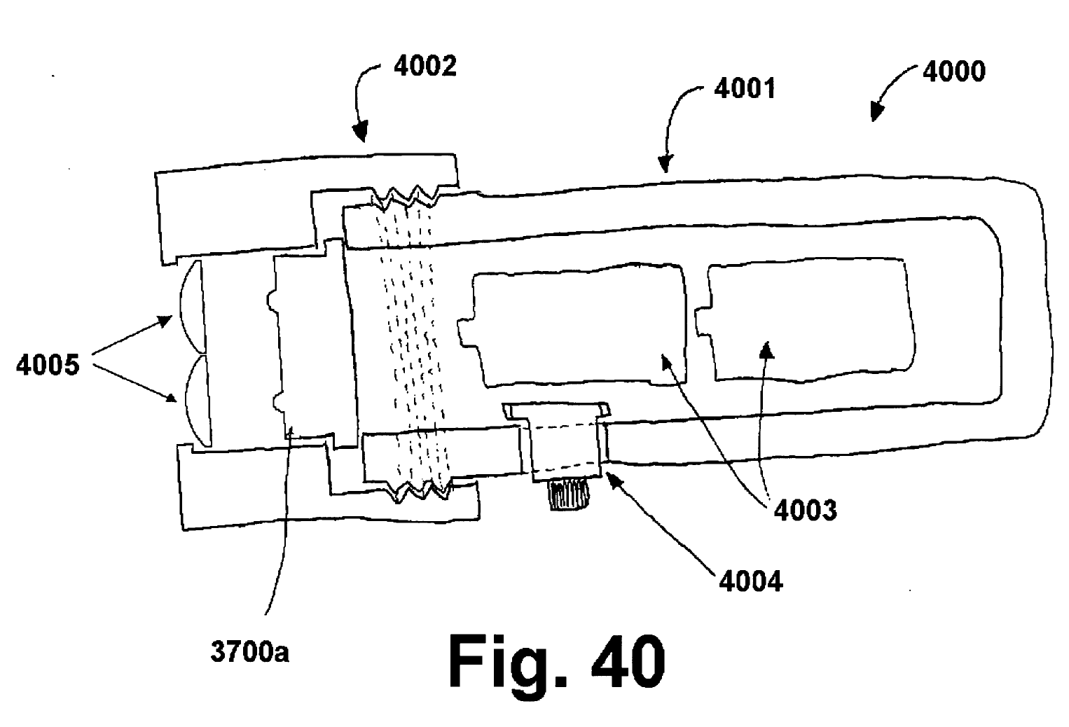

Referring to FIG. 40, an inspection lamp 4000 resembles a flashlight and has a cluster LED 3800 like that of FIG. 38. This inspection lamp 4000, in a manner similar to that of the inspection lamp of FIG. 39, typically comprises an outer casing 3901, a front capture ring 3902, one or more batteries 3903, a switch 3904, and electrical connections (not shown) and typically includes current limiting circuitry such as a dropping resistor (not shown). In addition, lenses 3905 are placed forward of the cluster LED 3700 to collimate the emitted radiation into a narrow beam.

The inspection lamp 4000 may further comprise additional parts such as charging circuitry, a charging jack, a heatsink for the cluster LED 3800, a loop for a lanyard, a lanyard, and/or one or more indicator lamps or indicator displays such as a battery status indicator. The outer casing 3901 may or may not be comprised in a single piece of material. The outer casing 3901 may or may not be made at least in part of plastic. The outer casing 3901 may or may not be made at least in part of metal. The outer casing 3901 or a portion thereof may be used for heatsinking purposes to dissipate heat from the cluster LED 3800.

The inspection lamp 4000 may, as shown, resemble a flashlight by having its outer casing 4001 in the form of a head section and a handle section sharing a common axis. Other arrangements are possible, including but not limited to having the head axis offset from the handle axis, having the head axis not parallel to the handle axis, having the handle bent or in the form of a pistol grip, or having a separate head and handle connected by a flexible gooseneck.

The lenses 4005 may have their axes in common with those of their corresponding domed regions of the cluster LED 3800. Alternatively, the lenses 4005 may have their axes closer together than the axes of their corresponding domed regions of the cluster LED 3800 in order to form beams that merge into each other at a finite distance forward of the inspection lamp 4000.

A variation can have more than one cluster LED 3800.

A variation may have the lenses 4005 omitted for purposes such as producing a wide radiation pattern. Alternatively, the lenses 4005 may be removable. The lenses 4005 may be movable so as to provide an adjustment in the characteristics.

It is to be understood that many of the features previously described for other embodiments may also be applied to a cluster LED and applications thereof. For the sake of brevity, the description of such features will not be repeated herein. Persons skilled in the art will be able to apply such features to cluster LEDs based on the principles described herein.

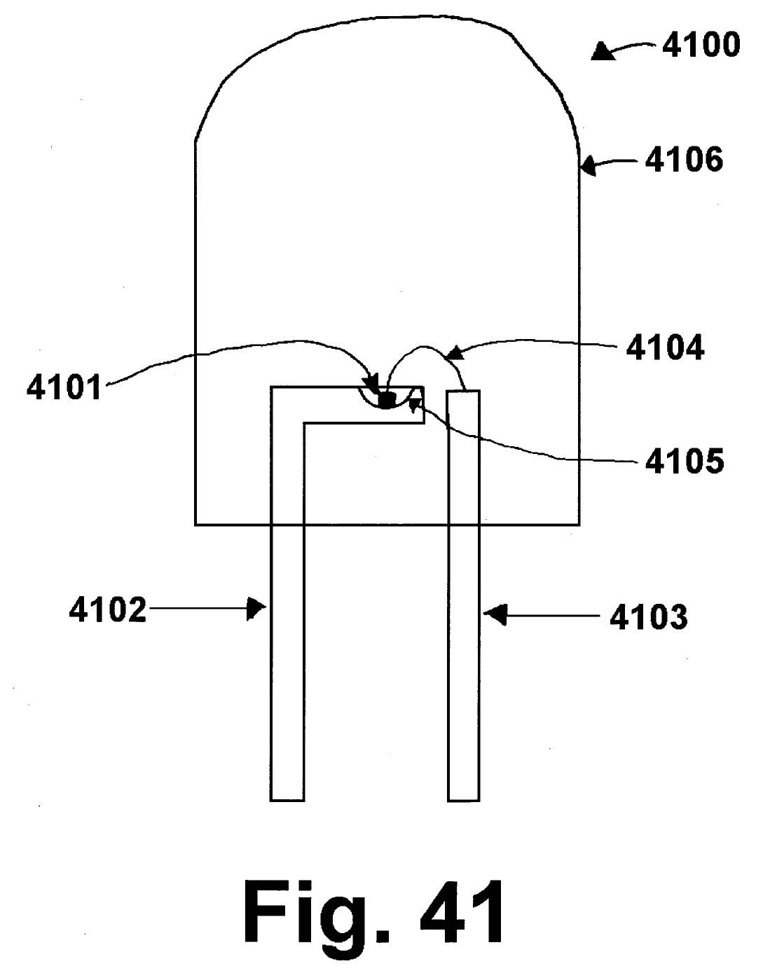

Referring to FIG. 41, an LED 4100 resembles previously existing LEDs in a “bullet” package, whose two most common sizes have diameters of approx. 3 and 5 mm. Such “bullet” packages are made in other sizes such as, for example, 10 mm in diameter. Although this description is generally made with reference to LEDs in such a “bullet” configuration, it is to be understood that the principles to be described herein for the use of stabilizing agents apply equally to other LED package configurations including, for example, the cluster LEDs 3700 and 3800 described above, rectangular surface mount LEDs and “high flux” AKA “spider” LEDs that have extra leads that are useful for heat dissipation.

“Bullet” style LEDs are useful for producing distinct beams that can easily be utilized by lenses and, possibly, sufficiently narrow and sufficiently defined as to not require additional optics, especially if the size of the package is larger such as 8-10 millimeters in diameter. As mentioned previously, smaller packages are not as good for producing narrow beams. The rectangular surface mount packages are often smaller still (2 millimeters wide or even smaller), and such smaller packages tend to produce wider radiation patterns. Surface mount ones are designed to be soldered onto copper traces on the top surface of a circuit board, as opposed to “through hole” ones which have leads that pass through holes into the circuit board and are soldered to copper traces on the bottom surface of a circuit board.

A light emitting semiconductor chip 4101 is attached to a cathode lead 4102. Near the cathode lead 4102 is an anode lead 4103. A bonding wire 4104 connects the positive terminal 4104b of the LED chip 4101 to the anode lead 4103.

If the LED chip 4101 is made with a conductive substrate material such as silicon carbide, then it is usually electrically connected to the cathode lead 4102 just by being attached to it. If the LED chip is made with a nonconductive substrate material such as artificial sapphire, then an additional bonding wire or similar device (not shown) is typically required to connect the negative terminal of the LED chip 4101 to the cathode lead 4102.

The LED chip 4101 is typically centered in a die cup 4105 which is a bowl shaped depression in the cathode lead 4102. The die cup 4105 is used as a reflector to reflect into a forward direction radiation which is emitted sideways from the LED chip 4101. An LED chip is often referred to as a “die”.

The stabilizing principles described herein will generally be applied to LEDs with LED chips 4101 emitting significant wavelength radiation that will cause degradation of the LED encapsulant over a time period that will affect operation of the LED in a given application. An indication of the encapsulant-damaging potential of an LED chip that emits significant radiation is the peak wavelength of the LED chip. LEDs that have a peak wavelength of 425 nanometers or less will benefit from the principles described herein in most applications since radiation from LED chips having a peak wavelength of 425 nanometers or less typically causes significant deterioration of epoxy encapsulates.

LEDs having a peak wavelength as long as 420 nanometers have had epoxy encapsulates damaged by the radiation produced by the LED chips at a rate that reduces the radiant output of these LEDs by half after several hundred hours of operation. LEDs with even longer peak wavelengths may have significant deterioration of their encapsulates over time. LEDs having epoxy encapsulates have been made with peak wavelengths as short as 365 nanometers, and in the future LEDs will be made having even shorter peak wavelengths.

LEDs having a peak wavelength of 390-410 nm, which is borderline ultraviolet to visible violet, have been found especially useful for inspection lamps used to detect fluorescent materials. It is anticipated that LEDs with shorter peak wavelengths such as near 365 nm will be found useful for such purposes. LEDs having longer peak wavelengths such as 450-460 nanometers have been found useful for some inspection lamp purposes, but epoxy degradation has been found generally not to be a problem with wavelengths near or longer than 460 nanometers.

However, LED chips with more intense output may cause significant epoxy degradation even if they produce wavelengths that do not typically cause degradation that affects the normal operation of the LED for particular applications.

Parts 4101-4104 are encapsulated in an encapsulating package 4106. Typically, the package 4106 is transparent; however, it may also be translucent or semi-translucent. Transparent packages 4106 do not scatter the radiation; whereas translucent packages scatter the radiation. If there are significant amounts of scattered and unscattered light then these may be considered to be semi-translucent. Transparent and translucent packages typically have 80% or more transmitted radiation; however, whether or not a package 4106 having lower % transmission is usable will depend on the particular application of the LED.

The package may be made of epoxy which is made resistant to damage from ultraviolet or violet radiation by having stabilizing agents mixed into the epoxy. Such agents can be chemicals, often referred to as ultraviolet inhibitors, such as, for example, phenolic inhibitors or UV absorbers or light stabilizers such as benzophenones, benzotriazioles, hindered amine light stabilizers (HALS) or antioxidants. Particular combinations of benzotriazoles or benzophenones with a sebacate type of HALS were found to be particularly effective when each is used in the range of 0.01-0.5 percent by weight of the encapsulate. Such agents can also be dyes that absorb any particularly damaging shorter wavelengths but not most of the radiation produced by the LED chip 4101.

Light stabilizers may include, for example, chemicals that quench polymer molecules or portions of polymer molecules excited by damaging radiation before the excitation leads to damage or is combined with additional excitation to be damaged.

Two processes take place simultaneously that tend to break down the LED encapsulate. First, light breaks down parts of the chemical structure to form free radicals that eventually recombine in the polymer matrix in undesirable ways. Additives (stabilizing agents) that interfere with this process in desirable ways are light stabilizers. The second process occurs in the presence of oxygen (e.g. in air) in which the free radicals combine with oxygen to produce undesirables. Additives (stabilizing agents) that interfere with this process are called antioxidants.

In general, antioxidants can be conveniently classified as hydrogen donors, hydroperoxide decomposers or radical scavengers. These materials are widely used in the plastics industry during steps such as melt processing. Well known hydrogen donors include, for example, substituted phenols, particularly those with substiuents in the 4-position and also substituents providing steric hindrance in the 2,6-position. Hydroperoxide decomposers include, for example, phosphites, phosphonites, sulfies, dialkyldithiocarbamates and dithiophosphates. Radical Scavengers include, for example, tetramethyl piperidine derivatives.

Light stabilizers are classified as either UV absorbers, quenchers or just light stabilizers (for the purposes of this description we will refer to this latter group as non-UV absorber light stabilizers). UV absorbers work by absorbing the radiation and emitting the added energy as something else e.g. as heat. Light stabilizers do not absorb UV radiation but work by some combination of other methods e.g. antioxidation, excited state quenching, radical scavenging. Quenchers pick up the energy from absorbers or from vulnerable portions of polymer molecules, where either of these have been excited into an unstable condition as a result of absorbing a photon that is typically of a UV or violet wavelength, and dissipate it to prevent degradation.

UV Absorbers include, for example:

substituted derivatives of benzophenone, particularly the class of hydroxybenzophenones, e.g.

2,4-dihydroxybenzophenone

2,2′-dihydroxy-4,4′-dimethoxybenzophenone

2-hydroxy-4-methoxybenzophenone

substituted derivatives of benzotriazole, particularly the class of phenylbenzotriazoles, e.g.

2-(2-hydroxy-5-methylphenyl)benzotriazole . . .

2-(2H-benzotriazol2-yl)-4,6-di-tert-pentylphenol substituted hydroxyphenyl triazines.

Light Stabilizers include, for example:

substituted tetramethylpiperidine derivatives, particularly the sebacates. e.g

bis(1-octyloxy-2,2,6,6-tetramethyl-4-piperidyl) sebacate.

Alternatively, the encapsulating package 4106 may be made of a material other than epoxy. Such a material may be a casting resin based on acrylic, polystyrene or both or a thermosetting form of polycarbonate that does not excessively absorb the desired radiation produced by the LED chip 4101. Further alternatively, the encapsulating package may be made of a thermoplastic. Molding of such a thermoplastic will require that such molding does not require temperatures which would damage the LED chip 4101 nor the electrical connections to it. Use of additives as above can be useful in encapsulant materials other than epoxy such as, for example, polyacrylates, styrenes, carbonates, urethanes, amides, acetals and olefins and various copolymers containing these groups. Materials other than epoxy may also benefit from stabilization, but epoxy is a material that has a great need for stabilizing agents. Some materials other than epoxy such as silicone rubber work well without stabilizing agents.

Any protective chemicals added to the material of the encapsulating package 4106 may be fluorescent or phosphorescent. The encapsulating package 4106 may contain one or more fluorescent or phosphorescent chemicals in addition to one or more protective chemicals. A small amount of fluorescence of the encapsulating package 4106 may be found useful to give a visible indication that the LED 4100 is operating should the radiation from the LED 4100 otherwise be essentially invisible. A small amount of visible light from any inspection lamps using the LED 4100 can be useful to give a visible indication of what area is being irradiated by such an inspection lamp. The concentration of any fluorescent or phosphorescent material in the encapsulating package 4106 must be low enough to not absorb an excessive portion of the radiation produced by the LED chip 4101 for the intended purpose of the radiation.

Epoxies may be modified as above to be more resistant to ultraviolet or violet radiation than those currently commercially available for use as LED encapsulates. The stabiling agents should not have excessive absorption of the radiation that an LED made with such an epoxy is intended to produce. Encapsulates other than epoxies can also be modified as described herein where resistance to degradation is desired.

The LED chip 4101 is normally mounted on the cathode lead 4102 but this is not always the case, especially if the chip is made with a nonconductive substrate material. The chip may be mounted on the anode lead 4103 or the chip may not be mounted on either lead. A bonding wire is typically used to make a connection to the chip from a lead that the chip is not mounted on, or is mounted on but in a manner lacking an electrical connection. The die cup 4105 is not necessary in all applications. For example, an inspection lamp using one or more LEDs like the LED 4100 may be optimized by using only the radiation emitted forward from the LED chip 4101 and not using any radiation that the LED chip 4101 would emit sideways to be utilized by a die cup 4105. By further example, the size of any necessary additional optics can be greatly reduced if such additional optics are only required to utilize radiation emitted generally forwards by forward surface of the LED chip 4101 and are not required to utilize radiation reflected forward by any die cup 4105.

Variants of the LED 4100 may contain additional parts such as one or more current-limiting devices such as resistors, regulating circuitry, or a flashing circuit

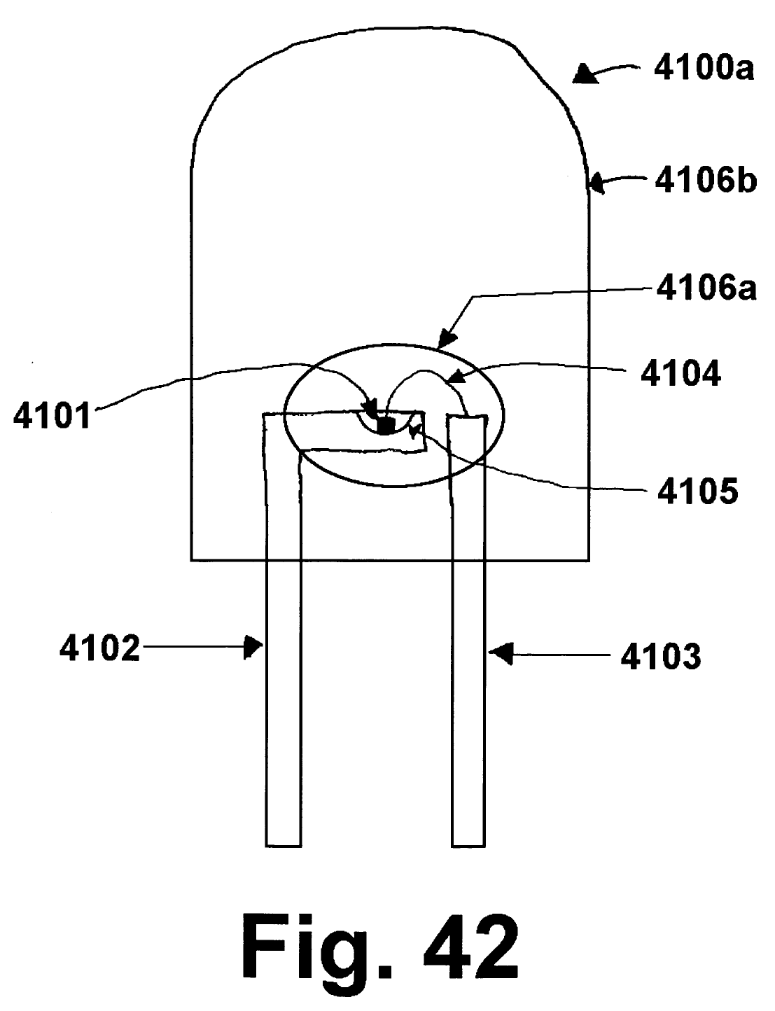

Referring to FIG. 42, an alternative LED 4100a is similar to that of LED 4100 of FIG. 41, except the encapsulant package comprises an inner layer 4106a and an outer layer 4106b. Since the concentration of ultraviolet radiation is higher in the inner layer 4106a, the LED 4100a can have an improvement in useful life if the inner layer 4106a is a material that is not damaged by ultraviolet radiation as quickly as the usual epoxies are, whether or not the outer layer 4106b is improved over the usual epoxies.

The inner layer 4106a may be solid, liquid, or a gel. The inner layer 4106a may be liquid or gel in form when the outer layer 4106b is placed or molded over the inner layer 4106a. The inner layer 4106a may or may not be a liquid or gel that solidifies during assembly of the LED 4100a or after assembly of the LED 4100a is complete. The inner layer 4106a may consist of a casting resin that may consist of acrylic or styrene or a combination of these materials. The acrylic may be methyl methacrylate. Such a casting resin may polymerize into polystyrene or polymethyl methacrylate or a combination of these. Alternatively, such a casting resin may be one that forms a polycarbonate.

Some stabilizing agents may tend to absorb radiation. Where the radiation is at a wavelength that is useful for particular applications then the absorption characteristics of the stabilizing agent should be taken into account. For example, polycarbonate tends to absorb wavelengths near and shorter than 390-395 nm or so. It may be advisable to use polycarbonate in applications where radiation of wavelengths longer than 390-395 nm is desired, or to reduce the amount of radiation below 390-395 nm that is absorbed by the polycarbonate, for example using the layering technique described below. As another example, some, but not all acrylics, absorb wavelengths in the 365-390 nm range. The inner layer 4106a may be applied in a form other than as a casting resin, such as a thermoplastic or an epoxy to which stabilizing agents have been added.

Should protective chemicals absorb an excessive amount of the radiation from the LED chip 4101 if they were used throughout the encapsulating package 4106a and 4106b, then they may not absorb an excessive amount of this radiation if used to a lesser extent or not used at all in the outer layer 4106b.

The outer layer 4106b is solid and it may be a usual epoxy such as Hysol OS 1600 or it may be a material that is not as easily damaged by ultraviolet radiation. The outer layer 4106b may be an epoxy that is protected with one or more stabilizing agents as discussed previously. For the reasons discussed previously for encapsulating package 4106, any protective chemicals added to the material of the encapsulating package outer layer 4106b or inner layer 4106a may be fluorescent or phosphorescent. The outer layer 4106b or the inner layer 4106a of the encapsulating package may contain one or more fluorescent or phosphorescent chemicals in addition to one or more protective chemicals. A small amount of fluorescence of either the outer layer 4106b or the inner layer 4106a or both of the encapsulating package 4106 may be found useful to give a visible indication that the LED 4100a is operating should the radiation from the LED 4100a otherwise be essentially invisible. A small amount of visible light from any inspection lamps using the LED 4100a can be useful to give a visible indication of what area is being irradiated by such an inspection lamp. The concentration of any fluorescent or phosphorescent material in the outer layer 4106b or the inner layer 4106a of the encapsulating package must be low enough to not absorb an excessive portion of the radiation produced by the LED chip 4101.

Fluorescence of the inner layer 4106a of the encapsulating package would typically be better than fluorescence of the outer layer 4106b of the encapsulating package for producing visible light that is emitted in approximately the same direction as the radiation from the LED chip 4101.

Referring again to FIG. 37, similarly to LED 4100 of FIG. 41, all of the parts 3701-3704 are encapsulated in an encapsulating package 3706, that may be made resistant to damage by ultraviolet or violet radiation by inclusion of stabilizing agents.

The encapsulating package 3706 may have two distinct layers of different encapsulates, or the encapsulating package 3706 may have distinct regions of UV-resistant encapsulant around the LED chips 3701 (like the LED of FIG. 2) within a package made of a less-protected or non-protected encapsulate.

Similarly to the LED 4100 of FIG. 41, the LED chips 3701 are typically but not necessarily mounted to their respective cathode leads 3702.

Once again, variations for some applications may lack the die cups 3705.

### EXAMPLES

The effectiveness of additives in prolonging the life of the epoxy resin was tested using a curing mixture consisting of a bis-phenol A type of epoxy resin. Effectiveness was tested using a monocrystalline silicon solar cell connected to a milliammeter in order to obtain an indication of the output of LEDs. The LEDs were powered through 200 ohm resistors from a 12 volt regulated voltage power supply, and this resulted in LED currents of approximately 40 milliamps. LED life expectancy would be expected and has been found to be roughly twice as great at the 20 milliamp current usually used by LED manufacturers for characterization of many LEDs as would be achieved at 40 milliamps. LED inspection lamps are often made having LED currents that can be considered excessive in order to achieve greater output of their desired radiation.

There are commercially available epoxy-encapsulated ultraviolet LEDs and LEDs producing mostly visible violet but marketed as “ultraviolet” having a halflife claimed by their manufacturers to be 2,000 hours at 20 milliammeter but having an actual halflife at 20 milliamps of only approx. 150-250 hours.

The performance of the additives is measure in terms of half-life, the time taken to reduce the output of the encapsulated LED by 50%. Test results are shown in Table 1 for additive nations that produced half-lives significantly above those of typical commercial products. of the tested combinations of stabilizing agents resulted in increases of over 200% of (3 the half-life of a typical bis-phenol A type of epoxy resin encapsulate.

TABLE 1

| | | | | | | | HALF |
|---|---|---|---|---|---|---|---|
| | Wt. % Additive | | | | | | LIFE |
| Test | DHBP | HMBP | DMBP | TIN 328 | HMBT | SEB1 | (hrs) |
| Commercial LED | | | | | | | 80 |
| bis-phenol A type Epoxy lacking additives | | | | | | | 30 |
| 1 | — | 0.05 | — | — | — | — | 98 |
| 2 | 0.5 | — | — | — | — | — | 99 |
| 3 | — | — | — | 0.5 | — | 0.5 | 99 |
| 4 | 0.01 | — | — | — | — | — | 105 |
| 5 | 0.05 | — | — | — | — | — | 113 |
| 6 | 0.05 | — | — | 0.05 | — | — | 114 |
| 7 | — | — | 0.05 | — | — | — | 130 |
| 8 | 0.05 | — | — | 0.05 | — | 0.05 | 141 |
| 9 | 0.02 | | | | 0.05 | 0.05 | 152 |
| 10 | — | — | — | — | 0.05 | 0.05 | 169 |

DHBP: 2,4-dihydroxybenzophenone

DHBP: 2,2′-dihydroxy-4,4′-dimethoxybenzophenone

HMBP: 2-hydroxy-4-methoxybenzophenone

HMBT: 2-(2-hydroxy-5-methylphenyl)benzotriazole . . .

TIN 328: 2-(2H-benzotriazol2-yl)-4,6-di-tert-pentylphenol: (Ciba Specialty Chemicals)

SEB1: bis(1-octyloxy-2,2,6,6-tetramethyl-4-piperidyl) sebacate.

Best results were obtained by the combination of the benzotriazoles and the sebacate or benzophenone and sebacate as seen in tests 8-10.It will be understood by those skilled in the art that this description is made with reference to the preferred embodiment and that it is possible to make other embodiments employing the principles of the invention which fall within its spirit and scope as defined by the following claims. For example, one or more LEDs of differing beamwidth may be used. The beams do not have to be focused at the target distance. The beams may be different from one another in width or other characteristics. It may be advantageous for beams of different wavelengths to have different target areas and/or a different target distance. Any of the lenses may be fresnel lenses. LED inspection lamps may use non conventional LEDs such as superluminescent diodes or laser diodes.

Laser diodes used in inspection lamps may be operated in a laser mode or a non laser mode. Laser diodes used in inspection lamps may be of types whose main application would be an associated generation of optical media that would require blue or violet laser diodes.

Inspection lamps having laser diodes may have cylindrical lenses or other optics that would correct the oblong beam shape that most laser diodes have. Alternatively, laser diode beams may be collimated with non cylindrical lenses in a scheme where non-cylindrical lenses are used to achieve a desired beam pattern. Laser diode beams may be collimated by both cylindrical and non-cylindrical lenses, or by one or more lenses that are “partially cylindrical” by having a second axis perpendicular to that of the beam and a third axis perpendicular to both the beam axis and the second axis, wherein the lens has distinct and different focal lengths for these second and third axes.

What is claimed is:

1. An LED lamp comprising:
a. an LED source having a plurality of LED chips, each chip producing a beam of radiation, and
b. a plurality of lenses, each lens for capturing a beam of radiation from an LED chip of the LED source,
wherein, the lenses collimate the captured beams of radiation to produce collimated beams of radiation and the lenses merge the collimated beams of radiation at a target distance.

2. The LED lamp of claim 1, wherein the LED source is a LED cluster comprising the plurality of LED chips within a single encapsulant package.

3. The LED of claim 2, wherein the lenses are part of the encapsulant package.

4. An LED lamp comprising:
a. an LED source having a plurality of LED chips, each chip producing a beam of radiation, and
b. a plurality of lenses, each lens for capturing a beam of radiation from an LED chip of the LED source,
wherein, the lenses collimate the captured beams of radiation to produce collimated beams of radiation and the lenses merge the collimated beams on radiation at a target distance, and wherein the LED chips emit radiation including wavelengths of 425 nm or less.

5. An LED source comprising:
a. a plurality of LED chips, each chip produces a beam of radiation,
b. at least one anode for connection, directly or indirectly, between a source of power for the LED source and one of the LED chips,
c. at least one cathode for connection, directly or indirectly, between a source of for the LED source and one of the LED chips, and
d. an encapsulant for encapsulating each of the LED chips, wherein the encapsulated LED chips are part of a single encapsulate package, the radiation from the LED chips is emitted from the encapsulate package, and the encapsulant comprises a UV stabilizing agent; so that, the encapsulant resists degradation by radiation produced from the LED chips, while allowing desired radiation from the LED chips to pass through the encapsulant and exit the LED.

6. The LED source of claim 5, wherein the encapsulant comprises an epoxy.

7. The LED source of claim 5, wherein the stabilizing agent comprises an antioxidant.

8. The LED source of claim 7, wherein the antioxidant comprises a hydrogen donor.

9. The LED source of claim 8, wherein the hydrogen donor comprises a substituted phenol.

10. The LED source of claim 9, wherein the substituted phenol comprises those with substituents in the 4-position.

11. The LED source of claim 9, wherein the substituted phenol comprises those with substituents providing steric hindrance in the 2,6- position.

12. The LED source of claim 7, wherein the antioxidant comprises a hydroperoxide decomposer.

13. The LED source of claim 12, wherein the hydroperoxide decomposer comprises a phosphate.

14. The LED source of claim 12, wherein the hydroperoxide decomposer comprises a phosphonite.

15. The LED source of claim 12, wherein the hydroperoxide decomposer comprises a sulfie.

16. The LED source of claim 12, wherein the hydroperoxide decomposer comprises a dialkyldithiocarbamate.

17. The LED source of claim 12, wherein the hydroperoxide decomposer comprises a dithiophosphate.

18. The LED source of claim 7, wherein the antioxidant comprises a radical scavenger.

19. The LED source of claim 18, wherein the radical scavenger comprises a tetramethyl piperidine derivative.

20. The LED source of claim 5, wherein the encapsulant comprises a light stabilizer.

21. The LED source of claim 20, wherein the light stabilizer comprises a quencher.

22. The LED source of claim 20, wherein the fight stabilizer comprises a non-UV absorber light stabilizer.

23. The LED source of claim 20, wherein the non-UV absorber light stabilizer comprises a substituted tetramethylpiperidine derivative.

24. The LED source of claim 23, wherein the substituted tetramethylpiperidine derivative comprises a sebacate.

25. The LED source of claim 24, wherein the sebacate comprises bis(1-octyloxy-2,2,6,6-tetramethyl-4-piperidyl) sebacate.

26. The LED source of claim 20, wherein the light stabilizer comprises a UV absorber.

27. The LED source of claim 26, wherein the UV absorber comprises a substituted derivative of benzophenone.

28. The LED source of claim 27, wherein the substituted derivative of benzophenone comprises a hydroxybenzophenone.

29. The LED source of claim 28, wherein the hydroxybenzophenone comprises 2,4-dihydroxybenzophenone.

30. The LED source of claim 28, wherein the hydroxybenzophenone comprises 2,2′-dihydroxy-4,4′-dimethoxybenzophenone.

31. The LED source of claim 28, wherein the hydroxybenzophenone comprises 2-hydroxy-4-methoxybenzophenone.

32. The LED source of claim 26, wherein the UV absorber comprises a substituted derivative of benzotriazole.

33. The LED source of claim 32, wherein the substituted derivative of benzotriazole comprises a phenylbenzotriazole.

34. The LED source of claim 33, wherein the phenylbenzotriazole comprises 2-(2-hydroxy-5-methylphenyl)benzotriazole.

35. The LED source of claim 33, wherein the phenylbenzotriazole comprises 2-(2H-benzotriazol 2-yl)-4,6-di-tert-pentylphenol.

36. The LED source of claim 26, wherein the UV absorber comprises a substituted hydroxyphenyl triazine.

37. The LED source of claim 5, wherein the encapsulant comprises a polyacrylate.

38. The LED source of claim 5, wherein the encapsulant comprises a styrene.

39. The LED source of claim 5, wherein the encapsulant comprises a carbonate.

40. The LED source of claim 5, wherein the encapsulant comprises an urethane.

41. The LED source of claim 5, wherein the encapsulant comprises an amide.

42. The LED source of claim 5, wherein the encapsulant comprises an acetal.

43. The LED source of claim 5, wherein the encapsulant comprises an olefin.

44. The LED source of claim 5, wherein the encapsulant comprises a copolymer of two or more polyacrylates, styrenes, carbonates, urethanes, amides, acetals and olefins.

45. The LED source of claim 5, wherein the encapsulant package is shaped to produce, for each LED chip, a round beam of the radiation emitted from each LED chip.

46. The LED source of claim 5, wherein the encapsulant package comprises a plurality of lenses forward from the LED chips; and wherein each lens captures a beam of radiation from an LED chip of the LED source, the lenses collimate the captured beams of radiation to produce collimated beams of radiation, and the lenses merge the collimated beams of radiation at a target distance forward of the LED source.

47. An LED lamp comprising:
a. the LED source of claim 5,
b. a plurality of lenses separate from the encapsulant package, and forward from the LED chips,
wherein, each lens captures a beam of radiation from an LED chip of the LED source, the lenses collimate the captured beams of radiation to produce collimated beams of radiation, and the lenses merge the collimated beams of radiation at a target distance.

48. A LED, comprising: one or more LED chips encapsulated in an encapsulant package, where the one or more LED chips have a peak emission wavelength of less than 425 nm and where the encapsulant is epoxy mixed with a stabilizing agent to resist damage to the epoxy by radiation from the LED chip(s) while allowing desired radiation from the LED chips to pass through the encapsulant and exit the LED.

49. The LED of claim 48, wherein the encapsulant comprises a mixture in which a piperidyl sebacate is combined with at least one of a benzophenone or benzotriazole in the range of 0.01-0.5 percent by weight of the encapsulate.

50. A light emitting diode having one or more LED chips encapsulated in an encapsulate package, where the LED chip(s) have a peak emission wavelength of less than 425 nm and where the encapsulant is epoxy mixed with a phenolic inhibitor to resist damage to the epoxy by radiation from the LED chip(s).

51. A light emitting diode having one or more LED chips encapsulated in an encapsulate package, where the LED chip(s) have a peak emission wavelength of less than 425 nm and where the encapsulant is epoxy mixed with a hindered amine light stabilizer to resist damage to the epoxy by radiation from the LED chip(s).

52. A light emitting diode having one or more LED chips encapsulated in an encapsulate package, where the LED chip(s) have a peak emission wavelength of less than 425 nm and where the encapsulant is epoxy mixed with a dye that absorbs radiation produced by the LED chip(s) so as to resist damage to the epoxy by radiation from the LED chip(s) while allowing desired radiation from the LED chips to pass through the encapsulant and exit the LED.

53. A light emitting diode having one or more LED chips encapsulated in an encapsulate package, where the LED chip(s) have a peak emission wavelength of less than 425 nm and where the encapsulant is an acrylic.

54. A light emitting diode as set forth in claim 53 where the acrylic is polymethylmethacrylate.

55. A light emitting diode having one or more LED chips encapsulated in an encapsulate package, where the LED chip(s) have a peak emission wavelength of less than 425 nm and where the encapsulant is a combination of an acrylic and polystyrene.

56. A light emitting diode as set forth in claim 53 where the encapsulant is in the form of a casting resin.

57. A light emitting diode as set forth in claim 54 where the encapsulant is in the form of a casting resin.

58. The LED of claim 48, wherein the stabilizing agent comprises an antioxidant.

59. An LED inspection lamp wherein at least one LED is the LED of claim 11.

60. The LED of claim 48, further comprising additional circuitry.

61. The LED of claim 60, wherein the additional circuitry limits or regulates current through the LED.

62. The LED of claim 48, where the LED is a cluster LED having at least two LED chips.

63. The LED of claim 62, wherein the cluster LED comprises: a domed region forward of each LED chip for optical purposes.

64. The LED of claim 63, wherein the domed regions have such optical properties as to form a usably collimated beam of radiation from the LED chips without additional optics.

65. The LED of claim 63, wherein the domed regions have such optical properties that additional optics would be used in order for a suitably collimated beam of radiation from the LED chips to be formed.

66. A LED having one or more LED chips encapsulated in an encapsulant package, where the LED chip(s) have a peak emission wavelength of less than 425 nm and where the encapsulant package comprises:
a. an inner layer surrounding the LED chip, with said inner layer being an encapsulant material which is not damaged by ultraviolet radiation as easily as epoxy is, and
b. an outer layer which is a rigid material.

67. The LED of claim 66 wherein the inner layer of the encapsulant package is rigid.

68. The LED of claim 67 where the inner layer of the encapsulant package is in the form of a casting resin.

69. The LED of claim 68 wherein the inner layer comprises an acrylic.

70. The LED of claim 69 wherein the acrylic is polymethylmethacrylate.

71. The LED of claim 68 wherein the inner layer comprises polystyrene.

72. The LED of claim 68 wherein the inner layer comprises a polycarbonate.

73. The LED of claim 66, wherein the LED is a cluster LED comprising at least two LED chips.

74. The LED of claim 73, further having a domed region forward of each of the LED chips for optical purposes.

75. The LED of claim 74, wherein the domed regions form a collimated beam of radiation from the LED chips.

76. An inspection lamp, suitable for causing visible fluorescence of visibly fluorescent substances and having at least one cluster LED as set forth in claim 62.

77. The LED inspection lamp of claim 76, where the LED inspection lamp further comprises the additional optics typically required to form a collimated beam of radiation from the cluster LED.

78. An LED inspection lamp wherein at least one LED is the LED of claim 66.

79. An inspection lamp, suitable for causing visible fluorescence of visibly fluorescent substances and having a cluster LED as set forth in claim 74.

80. The LED inspection lamp of claim 79, further comprising additional optics, separate from the cluster LED, to form a suitably collimated beam of radiation from the cluster LED.

81. An epoxy encapsulate, suitable for making LEDs having a peak wavelength of less than 425 nanometers, wherein the encapsulant comprises: a stabilizing agent to resist damage to the epoxy by radiation produced by LED chips in the LEDs.

82. A LED, suitable for use in an LED inspection lamp, the LED comprising: two or more LED chips with a peak wavelength of less than 425 nanometers in a single encapsulant package.

83. A LED, suitable for use in an LED inspection lamp, the LED comprising: two or more LED chips with a peak wavelength of between than 425 and 450 nanometers in a single encapsulant package.

84. An LED comprising:
a. one or more LED chips,
b. an encapsulant for encapsulating one or more of the LED chips,
c. a stabilizing agent within the encapsulate, wherein the stabilizing agent resists degradation of the encapsulant by radiation emitted from one or more of the LED chips.

85. The LED of claim 84, wherein the encapsulant comprises an epoxy.

86. The LED of claim 84, wherein the stabilizing agent comprises: one or more of a phenolic inhibitor, an antioxidant, a hindered amine light stabilizer, a light stabilizer other than hindered amine light stabilizers, a light absorber that absorbs damaging wavelengths while transmitting desirable wavelengths.

87. The LED of claim 84, wherein one or more of the LED chips emits radiation at a peak wavelength of 425 nm or less.

88. The LED of claim 84, wherein the encapsulant comprises one or more domed regions, each domed region being forward of an LED chip.

89. An LED lamp comprising: the LED of claim 88, and a lens forward of each domed region of the LED.

90. The lamp of claim 89, wherein the lenses collimate the radiation from the LED into a beam.

91. A flashlight comprising the LED of claim 84.

92. An inspection lamp having light emitting diodes as a source of radiation suitable for causing visible fluorescence of fluorescent materials, where said light emitting diodes are substantially non-identical in spectral characteristics of their emitted radiation, such that at least one but not all of said light emitting diodes in said inspection lamp produce wavelengths of radiation that are favorable for causing visible fluorescence of some fluorescent materials, and such that one or more different said light emitting diodes in said inspection lamp produce substantially different wavelengths of radiation which are more favorable than the wavelengths of first said light emitting diode(s) for causing visible fluorescence of some fluorescent materials other than first said fluorescent materials.

93. An inspection lamp as set forth in claim 92 where at least one light emitting diode has a peak emission wavelength in the ultraviolet and having at least one light emitting diode with a peak emission wavelength that is visible but suitable for causing visible fluorescence of fluorescent materials.

94. An inspection lamp as set forth in claim 92 where at least one light emitting diode produces mostly blue visible light and where at least one light emitting diode produces mostly visible violet light or ultraviolet radiation.

95. An inspection lamp as set forth in claim 3 where at least one light emitting diode has a peak emission wavelength in the range of 425 to 480 nanometers and at least one light emitting diode has a peak emission wavelength in the range of 360 to 430 nanometers.

96. An inspection lamp having:
a. Two or more light emitting diodes which produce radiation suitable for causing visible fluorescence of fluorescent materials,
b. A lens forward from each of said light emitting diodes to collimate the radiation from each light emitting diode into a beam, such that the beams of radiation individually associated with each of said light emitting diodes project forward from said lenses and merge together.

97. The LED source of claim 5, wherein the encapsulant package is shaped to produce, for each LED chip, a beam of the radiation that is in the form of an image of each LED chip.

98. The LED lamp of claim 47, wherein each lens projects an image of an LED chip to form a collimated beam of the radiation produced by each LED chip.

99. The LED lamp of claim 47, wherein the LED has a round domed region forward of each LED chip, and wherein each lens projects an image of each domed region to form a collimated beam of the radiation produced by each LED chip.
